(19) United States
(12) Patent Application Publication
(10) Pub. No.: US 2007/0285643 A1
(43) Pub. Date: Dec. 13, 2007

(54) Method For Manufacturing Reflective Optical Element, Reflective Optical Elements, Euv-Lithography Apparatus And Methods For Operating Optical Elements And Euv-Lithography Apparatus, Methods For Determining The Phase Shift, Methods For Determining The Layer Thickness, And Apparatuses For Carrying Out The Methods

(75) Inventors: Marco Wedowski, Aalen (DE); Nadyeh Shariloo, Aalen (DE); Frank Scholze, Berlin (DE); Johannes Tuemmler, Berlin (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 10/598,481

(22) PCT Filed: Mar. 4, 2005
(86) PCT No.: PCT/EP05/50985

§ 371 Date: Jun. 18, 2007

(30) Foreign Application Priority Data
Mar. 5, 2004 (DE) 10 2004 011 356.4
Mar. 5, 2004 (DE) 10 2004 011 355.6

(51) Int. Cl. G03B 27/54; G01B 9/00

(52) U.S. Cl. 355/67; 356/124

(57) ABSTRACT

The invention relates to a method for manufacturing of a multilayer system (25) with a cap layer system (30), in particular for a reflective optical element for the extreme ultraviolet up to the soft x-ray wavelength range, comprising the steps of: 1. preparing a coating design for the multilayer system (25) with cap layer system (30); 2. coating a substrate (20) with the multilayer system (25) with cap layer system (30); 3. spatially resolved measurement of the coated substrate in terms of reflectance and photoelectron current in at least one surface point; 4. comparison of the measured data with data modelled for different thicknesses of the layers (31, 32, 33) of the cap layer system (30) and/or the layers (21, 22, 23, 24) of the multilayer system (25) for determining of the thickness distribution obtained by the coating; 5. if necessary, adjusting of the coating parameters and repeating steps 2 to 5 until the coated thickness distribution coincides with the design. The invention also relates to further manufacturing methods, reflective optical elements, EUV-lithography apparatuses, and methods for operating optical elements and EUV-lithography apparatuses as well as methods for determining the phase shift, methods for determining the layer thickness, and apparatuses for carrying out the methods.

### TECHNICAL FIELD OF THE INVENTION

The invention relates to a method for qualifying a reflective optical element and a method for determining a thickness profile of a multilayer system and/or a cap layer system of an optical element for reflecting radiation.

Furthermore, the invention relates to a method for manufacturing multilayer systems with a cap layer system, in particular reflective optical elements for the extreme ultraviolet up to the soft x-ray wavelength range, a corresponding reflective optical element for the extreme ultraviolet up to the soft x-ray wavelength range as well as an EUV-lithography apparatus with at least one such reflective optical element.

Furthermore, the invention relates to a method for manufacturing a reflective optical element for the extreme ultraviolet up to the soft x-ray wavelength range with a cap layer system of constant thickness as well as an EUV-lithography apparatus with at least one such reflective optical element.

The invention also relates to methods for determining the phase shift of a standing electromagnetic wave in the extreme ultraviolet up to the soft x-ray wavelength range at the free interface of a multilayer system. The invention further relates to methods for determining the thickness of a cap layer system on a multilayer system being preferably used in the manufacturing methods described above. The invention relates, moreover, to apparatuses for carrying out these methods.

The invention also relates to a reflective optical element comprising a multilayer system with a cap layer system with at least one layer consisting of a transition metal, the multilayer system being optimized for an operating wavelength in the extreme ultraviolet up to the short x-ray wavelength range, an EUV-lithography apparatus with at least one such reflective optical element as well as a method for operating of reflective optical elements.

The invention further relates to an EUV-lithography apparatus and a method for operating such an EUV-lithography apparatus, as well as a reflective optical element.

### BACKGROUND OF THE INVENTION

Reflective optical elements for the soft x-ray up to the EUV wavelength range (e.g. wavelengths of between 5 nm to 20 nm) such as photo masks or multilayer mirrors, for example, are required particularly for use in the EUV-lithography of semiconductor elements. Typical EUV-lithography apparatuses comprise eight or more reflective optical elements. In order to still reach a sufficient total intensity of the operating radiation, the mirrors have to exhibit as high a reflectance as possible, as the total intensity is proportional to the product of the reflectances of the individual mirrors. These reflective optical elements should maintain such a high reflectance over their service life. Furthermore, the homogeneity of the reflectance across the surface of the reflective optical elements must be maintained during their service life. The reflectance and the lifetime of such reflective optical elements are particularly impaired by contamination of the surface during irradiation at the operating wavelength through deposition of carbon and oxidation of the surface.

The reflective optical elements are contaminated by residual gases from the vacuum atmosphere during operation. Thus, molecules of the residual gas are first adsorbed at the surfaces of the reflective optical elements and then broken up by high-energetic photon radiation through emission of secondary electrons and, to some extent, of photoelectrons as well. When hydrocarbons are present in the residual gas atmosphere, a carbon layer is generated which reduces the reflectance of a reflective optical element about 1% per nm of thickness. For a partial pressure of hydrocarbon of about 10⁻⁹ mbar, a layer with a thickness of 1 nm is obtained already after about 20 hours. As e.g. EUV-lithography apparatuses do not allow the necessary throughput with a loss of reflectance of 1% per reflective optical element, the contamination layer has to be removed in a cleaning process which may last up to 5 hours. Furthermore, such a cleaning process involves the risk that the surface of the reflective optical element is damaged, e.g. roughened up or oxidized, such that the original reflectance cannot be attained again.

Residual gas molecules containing oxygen may contribute to the oxidation of the surfaces. Thus, the unprotected surface of a reflective optical element may be destroyed in a few hours.

It has also already been proposed to keep the general degradation and, in particular, contamination by carbon-comprising substances as small as possible or to make their effects controllable not only through material selection but also through the geometry of the cap layer system. By a specific choice of the thickness distribution of the cap layer system, one can control how much contamination is created in which surface region. In this way, the contamination is dependable and can be taken into consideration for the operation or conception of reflective optical elements, optical systems, and EUV-lithography apparatuses.

The contamination of optical elements in an x-ray optical system can be determined by measuring the photoelectrons at the respective optical element and recording their energy spectrum. It is also possible to deduce contamination from the intensity at certain photoelectron energies.

The simultaneous measurement of reflectance and photoelectron current for the characterization of multilayer systems has already been proposed before and has been effected based on the assumption that the phase shift between reflectance and photoelectron current is generally π/2.

Here is already known a method for detecting contamination on a permanently prescribed substrate, and for determining the thickness of contamination should the latter be present. The first step in this case is for the substrates to be irradiated in a spatially resolved fashion with sufficiently energetic polychromatic radiation, after which the photoelectron current emanating from the substrate is determined. Ultraviolet radiation is used for the characterization. The measurement is restricted to the contamination to be detected, and no characterization of the substrate is made.

The reflectance of electromagnetic radiation at a multilayer system depends both on the wavelength λ that is applied to the surface, and on the incidence angle φ thereof with respect to the surface normals. The reflectance R (λ, φ) of an optical element is yielded in this case from the intensity of the reflected radiation divided by the intensity of the incident radiation. In the case of spectral resolution, the reflectance is measured at a constant incident angle and variable wavelength. In the case of angular resolution, the reflectance is measured at a constant wavelength λ, and the incident angle φ of the radiation is tuned.

As a rule, synchrotron radiation sources or laser-generated and/or discharge-generated plasma sources are used to carry out reflectometric measurements on multilayer systems for the extreme ultraviolet wavelength region (EUV) and the soft x-ray wavelengths region (for example wavelengths from approximately 1 nm to 20 nm). Synchrotron radiation is very well suited for reflectometric measurements, because synchrotron radiation is a very brilliant, “white” radiation, that is to say can be collimated very well and is very broadband. Moreover, this radiation is available free from contamination in vacuum.

The polychromatic radiation of a synchrotron or a plasma source is usually collimated and monochromatized for use in reflectometry. The radiation prepared in this way is then used for spectral or angularly dependent measurements of reflectance. A photodiode, for example, can be used as photon detector for the reflected radiation. The intensities are measured serially as a rule, that is to say the measurements consist in a time sequence of parameter changes and photon intensity measurements. A reference measurement is typically performed at all radiation sources in order to determine the intensity of the incident radiation.

Reflectometric investigations of reflective optical elements based on multilayer systems certainly cover some properties that are important for their use in EUV lithography, such as, for example, the maximum reflectance, the wavelength at which the maximum reflectance is reached, and the bandwidth of the reflectance curve, it being possible, for example, to deduce compliance with the overall layer thickness specification from the wavelength of the maximum reflectance. However, there is a great disadvantage that it is always only possible to determine properties averaged over all the individual layers.

It has been proposed to determine the structure of the layers of a multilayer system, that is to say the densities of the layers and, in particular, the roughness at the layer interfaces by measuring both the reflectance and the photoelectron current of a sample simultaneously. For this purpose, radiation in the x-ray range is used. This proposal is based on the assumption that the spectrum of the current, normalized to the radiation dose, is proportional to the spectrum of the standing x-ray wave which is formed in the resonant case, and that the shape of the spectrum depends on layer structure and interface roughness. In an appropriate measuring apparatus, monochromatic light in the range of about 100 eV is provided with the aid of a monochromator. The light is directed onto a sample having a rotational degree of freedom for changing the angle of incidence. Typically, photodiodes are used for such reflectance measurements. For measuring of the radiation dose, a grid being connected in a conducting fashion to the sample and located in the beam path between the monochromator and the sample is used. For measuring the current flowing through the sample, the multilayer system is connected to an ammeter via a cable.

It was further proposed in the past to detect defects at reflective optics composed of multilayer systems in a spatially resolved fashion by measuring photoelectrons, for example, in the standing wave field. Local deviations in the intensity of the photoelectron signal from the maximum achievable intensity at regions free from defects are interpreted as an indication for a local defect. The surface of the multilayer system is scanned for this purpose with radiation of constant wavelength. The deformations caused by thermal loading at mirrors of an EUV illumination system are also determined in a similar way by measuring the photoelectron current at the respective mirror.

Conventional multilayer systems are produced by depositing materials with different refractive indices and/or different absorption coefficients on a substrate in several layers, one upon the other. Those are used as mirrors, particularly in the extreme ultraviolet wavelength range. Other possible applications of multilayer systems are e.g. anti-reflection coatings of optical elements in the visible wavelength range.

The reflectance of electromagnetic radiation of a multilayer system is based upon interference among the radiation reflected at multiple interfaces of the multilayer system, being described by Bragg's law. This reflectance is therefore of a dispersive nature. The reflectance at the interface between two such layers amounts to several per thousands for angles which are larger than the critical angle for electromagnetic radiation in a wavelength range <50 nm. For such angles, reflectances of an order of magnitude of up to 70% can be obtained with multilayer systems. Multilayer systems are therefore used to attain high reflectances for large angles relative to layer surfaces and may therefore also be used as dispersive elements.

A multilayer system for the reflection of short wavelengths consists of successive periods of two or more layers of materials, each with different refractive indices and thicknesses e.g. in the order of magnitude of the wavelength of the reflected radiation. The total reflectance of a multilayer system is determined by the order of magnitude of reflection per interface, i.e. the difference of refractive indices on the one hand and absorption coefficients on the other hand.

The thicknesses of the individual layers are usually constant across the multilayer thickness for each material. Depending on the specifications of the mirror in terms of the reflectance profile, any other imaginable multilayer system is also possible.

In the EUV range, one predominantly begins with systems with molybdenum/silicon and/or molybdenum/beryllium. For protection against external influences, e.g. contamination, a protecting cap layer system may be provided on the surface of the reflective optical element. In the following the term cap layer system is to be understood in the following way: a cap layer system is a system of one or several layers deposited on top of the periodic multilayer system described before. A cap layer system may comprise one or more layers of a transition metal, such as for example ruthenium or iridium or alloys or chemical compounds comprising ruthenium or iridium. A topmost cap layer may even be formed due to contamination, e.g. by deposition of a carbon layer.

Depending on the choice of selected cap layer materials, the contamination, respectively, degradation of the surface of the reflective optical elements may be favourably affected. By selecting the thickness of the one or more cap layers, it may be accomplished that the reflectance of the reflective optical element does not decrease too strongly despite of the cap layer system.

Optical elements made of a substrate and a multilayer system being optimized for high reflectances at a given wavelength, e.g. photo masks or mirrors for the extreme ultraviolet wavelength range (EUV), are required particularly for use in EUV-lithography of semiconductor elements.

In order to deposit highly uniform layers onto flat or curved substrates, one may proceed by first determining the particle flow of the depositing source by using a test substrate. There from, layer thickness profiles may be calculated taking into account different relative movements between substrate and source. Thus, it can be determined how the desired thickness distribution may be obtained. For optimization of coating parameters, layer thicknesses actually acquired are measured by abrasion or etching in places of the coating, and measuring the difference in height to the remaining coating with the aid of profile meters. With common profile meters, vertical resolutions of 3 nm minimum can be attained.

The iterative optimization of design and production processes of multilayer systems for reflective optical elements of two alternating deposited materials is already known. First, a first layer of both materials is deposited in each case. Their thickness distribution is determined and subsequently the coating parameter for the desired layer thicknesses of the remaining layers is fixed. The characterization of layer thicknesses, the periodic length of the multilayer system and the roughness of the surfaces is determined by means of a reflectance measurement and its comparison with modelled data.

As a further development of condenser systems for EUV-lithography systems consisting of a collector unit and a grating wherein the grating may be coated by a multilayer system, a collector unit for wavelengths smaller than 193 nm up to the EUV wavelength range is known, whose main element is a mirror shell for generating a uniform and telecentric image of the radiation source which comprises a grating structure on its surface. This grating structure diffracts different wavelengths into different directions. With the aid of a slit stop, the desired diffraction order, respectively wavelength, may be selected. Incidentally, the slit stop screens particles which may possibly originate from the radiation source.

Control loops for the prevention of contaminations of surfaces of reflective optical elements on the basis of multilayer systems in an evacuated system comprising a residual gas atmosphere during the irradiation with operating wavelengths in the EUV-region are already known. Therein, a photoelectron current generated by photoelectron emission of the irradiated surface of the multilayer system is measured. The regulation of the gas composition during irradiation is carried out in dependence of the measured photoelectron current so that by reaching or exceeding a threshold level, a gas is supplied to the closed system and subsequently, before or after reaching another threshold level, the supply of said gas is at least reduced.

For the reduction of contamination of optical elements which comprise a multilayer system, it has been assumed that the layer material and/or the layer thickness of at least one layer of the multilayer system should be chosen in such a way that the standing electromagnetic wave being formed during reflection of the incident operating wavelength has a node of the electrical field strength in the region of the free interface of the multilayer system. Thereby, the emission of photoelectrons from the surface is minimized which would otherwise generate reactions, e.g. with the residual gas, possibly leading to increased contamination.

It has also been pointed out in the past that avoidance of contamination of surfaces of reflective optical elements for the soft x-ray and the extreme ultraviolet wavelength range may be particularly efficient, if, on the one hand, the reflective optical elements are provided with a cap layer which contains one or several transition metals, and, on the other hand, the irradiation at the operating wavelength is carried through in an evacuable closed system having a residual gas atmosphere, wherein a reductive gas or mixture of reductive gases and an oxidizing gas or mixture of oxidizing gases should be present simultaneously in the residual gas atmosphere. The partial pressures can be adjusted such that oxidizing and reductive processes on the surface of the reflective optical element are balanced such that no appreciable contamination can take place. Particularly preferred is a residual gas atmosphere consisting of a hydrocarbon, water, and oxygen.

Lithography apparatuses for the x-ray region which comprise various detectors in order to control the radiation intensity during the irradiation of the mask and the wafer are already known. Through this, deformations of the mirrors which are caused by thermal load are detected and the contamination state of the mirror surfaces is controlled. Particularly for the detection of deformations and the contamination state, it is resorted to the photoelectric effect. The detected deformations are balanced during the irradiation process. If contamination of a mirror is detected, a signal is given that the mirror has to be changed or maintenance has to be carried through.

It has also already been considered to perform in situ cleaning of EUV-lithography apparatuses and their parts, respectively, by using EUV-radiation. For example, in addition to the actual operation reticles, cleaning reticles may be provided which are optimized for directing the cleaning beam to the locations to be cleaned.

It has been attempted to avoid contaminations due to oxidation by adding hydrocarbons, in particular alcohol, to the residual gas atmosphere. It has in effect been expected that a self-terminating carbon layer is deposited on the surface of the reflective optical element, yet long-term studies >100 hours have shown that the carbon layer slowly grows further.

It is known that the carbon contamination can be removed by addition of a cleaning gas. Oxygen, hydrogen, and water have been proposed as a cleaning gas. However, there remains the problem that not only the contaminating carbon layer is removed but possibly an oxidation of the surface lying below the contamination may be induced as well.

It has been proposed to achieve a synchronous removal of carbon deposits from the surface of a multilayer system of Mo/Si without a cap layer system, i.e. with a terminating silicon layer, by addition of ethanol and water in a ratio of 2:1 to the residual gas atmosphere.

A protective layer has been described which considerably reduces the oxidation susceptibility, which prolongs the lifetime of reflective optical elements. For economical use of reflective optical elements, e.g. in a EUV-lithography apparatus, lifetimes of several years have to be achieved.

A further approach to avoid losses in reflectance by contamination consists in providing a photocatalytic protective layer, e.g. and oxide of a transition metal, so that during irradiation with EUV-radiation free oxygen radicals are generated which react with the carbon deposits to volatile compounds. Oxygen, water and/or peroxide are supplied where appropriate.

### SUMMARY OF THE INVENTION

It is an object of the invention to provide a manufacturing method for multilayer systems with a cap layer system. Furthermore, it is an object of the invention to provide a reflective optical element produced by such a method and a EUV-lithography apparatus in which such an element is used.

Moreover, it is an object of the present invention to provide a manufacturing method for a reflective optical element with a cap layer system of constant thickness as well as a corresponding reflective optical element and an EUV-lithography apparatus operated with the same.

The object of the invention further consists in providing a method for experimentally determining the phase shift of the standing wave at the free interface of a multilayer system and for determining layer thicknesses, and an arrangement suitable for the purpose, in particular for use in the manufacturing methods mentioned above.

A further object of the present invention is to provide a reflective optical element for the extreme ultraviolet up to the soft x-ray wavelength range being optimized in terms of contamination, an EUV-lithography apparatus based thereon, as well as a method for operating such an EUV-lithography apparatus.

The object is further realized in providing an EUV-lithography apparatus with as high a lifetime as possible as well as a method for operating such an EUV-lithography apparatus.

The invention is realized in a method for manufacturing a multilayer system with a cap layer system, in particular reflective optical elements for the extreme ultraviolet up to the soft x-ray wavelength range, comprising the steps of:

1. preparing a coating design for the multilayer system with cap layer system;

2. coating a substrate with the multilayer system with cap layer system;

3. spatially resolved measurement of the coated substrate in terms of reflectance and photoelectron current in at least one surface point;

4. comparison of the measurement data with data modelled for different thicknesses of the layers of the cap layer system and/or the layers of the multilayer system for the determination of the thickness distribution obtained after coating;

5. if necessary, adjusting the coating parameters and repeating steps 2 to 5 until the coated thickness distribution coincides with the design;

as well as a reflective optical element for the extreme ultraviolet up to the soft x-ray wavelength range manufactured in such a way and an EUV-lithography apparatus with at least one such reflective optical element.

In a particular aspect, the invention is a method for manufacturing a reflective optical element for the extreme ultraviolet up to the soft x-ray wavelength range with a cap layer system of constant thickness comprising the steps of:

1. preparing a coating design for the multilayer system with cap layer system;

2. coating of the substrate with the multilayer system with cap layer system;

3. measurement of the coated substrate in terms of reflectance and photoelectron current in at least one surface point;

4. comparison on the measurement data with data modelled for different thicknesses of the layers of the cap layer system for the determining of the thickness distribution achieved due to the coating;

5. if necessary, adjusting of the coating parameters and repeating steps 2 to 5 until the coated thickness distribution coincides with the design;

as well as a reflective optical element for the extreme ultraviolet up to the soft x-ray wavelength range with a cap layer system of constant thickness manufactured in this way and an EUV-lithography apparatus with at least one such reflective optical element.

A further object of the invention is realized by means of methods for determining the phase shift of a standing electromagnetic wave in the extreme ultraviolet up to the soft x-ray wavelength range at the free interface of a multilayer system, having the steps of:

1. illuminating the free interface of a multilayer system with radiation in the extreme ultraviolet up to the soft x-ray wavelength range;

2. spectrally resolved or angularly resolved measurement, or measurement for specific combinations of wavelength and angular setting of the reflectance and the photoelectron current; and

3. determining the profile of the photoelectron current in the region of maximum reflectance, and ascertaining therefrom the phase shift of the standing electromagnetic wave at the free interface.

This object is also achieved by means of methods for determining the thickness of a cap layer system on a multilayer system from the phase shift of a standing electromagnetic wave in the extreme ultraviolet up to the soft x-ray wave range at the free interface of a multilayer system, having a cap layer system, having the steps of:

1. illuminating the free interface of a multilayer system with radiation in the extreme ultraviolet up to the soft x-ray wavelength range;

2. spectrally resolved or angularly resolved measurement, or measurement for specific combinations of wavelength and angular setting of the reflectance and the photoelectron current; and

3. determining the profile of the photoelectron current in the region of maximum reflectance, and ascertaining therefrom the phase shift of the intensity of the standing electromagnetic wave forming at the free interface in the case of resonance; and

4. comparison with an already known photoelectron current profile with reference to the phase shift of the corresponding standing electromagnetic wave at the free interface, and determining the difference in thickness by ascertaining the difference between the two phase shifts.

The invention is furthermore realized by means of methods for determining the thickness of a cap layer system on a multilayer system from the phase shift of a standing electromagnetic wave in the extreme ultraviolet up to the soft x-ray wave range at the free interface of a multilayer system, having a cap layer system, having the steps of:

1. illuminating the free interface of a multilayer system with radiation in the extreme ultraviolet up to the soft x-ray wavelength range;

2. spectrally resolved or angularly resolved measurement, or measurement for specific combinations of wavelength and angular setting of the reflectance and the photoelectron current; and

3. determining the profile of the photoelectron current in the region of maximum reflectance, and ascertaining therefrom the phase shift of the standing electromagnetic wave at the free interface;

4. comparison with the experimentally ascertained profile of the photoelectron current in the region of the maximum reflectance with model calculations executed for different thicknesses of the cap layer system.

Method steps are advantageously carried out in a spatially resolved fashion, and the experimentally obtained data are advantageously additionally compared with reference data that are obtained from specified multilayer systems, and/or are measured on the multilayer system in the absence of resonance.

This object is achieved, furthermore, by means of apparatuses for carrying out the methods for determining the phase shift and layer thicknesses as set forth in the claims, the apparatuses having means for spatially and spectrally setting incoming radiation, as well as a vacuum chamber in which a photon detector, a photoelectron detector and a sample holder are arranged, an electrically conducting wide angle element being used as photoelectron detector, and the means for spatially and spectrally setting incoming radiation being optimized to provide a narrowband beam of small beam diameter, or are optimized to provide a narrowband beam of small divergence.

The devices advantageously have a radiation source for extreme ultraviolet and/or soft x-radiation.

The sample holder advantageously has three degrees of translational freedom and three degrees of rotational freedom.

A device is advantageously provided for generating a defined electric field in the vicinity of the sample.

Two or more samples are advantageously introduced into the apparatus for measurement, and they are electrically connected to one another in series.

The invention is further realized in a reflective optical element for the extreme ultraviolet up to the soft x-ray wavelength range comprising a multilayer system with cap layer system with at least one layer consisting of a transition metal or an alloy, compound or mixture containing a transition metal, being optimized for an operating wavelength in the extreme ultraviolet up to the soft x-ray wavelength range which is characterized in that at least one layer- or cap layer-thickness is chosen in such a way that during irradiation at the operating wavelength a standing electromagnetic wave is formed in such a way that it forms an intensity maximum in the area of the free interface of the reflective optical element. In further developments, the invention is realized in an EUV-lithography apparatus with at least one such reflective optical element having an evacuable housing and at least two inlets which open towards the reflective optical element and are used for supplying an oxidizing gas or mixture of gases and a reductive gas or mixture of gases, as well as a method for operating such a reflective optical element in a closed system having a residual gas atmosphere consisting of a hydrocarbon, water, and oxygen, in which the partial pressure of the hydrocarbon is increased in such a way that carbon is deposited on and/or in the topmost layer when the irradiation at the operating wavelength is started, such that the intensity maximum of the forming standing electromagnetic wave is located at the free interface.

In further developments, the invention is realized in a method for operating said reflective optical element in a closed system with a residual gas atmosphere comprising a reductive gas fraction and an oxidizing gas fraction, wherein the partial pressures of the gas fractions are adjusted in such a way that oxidizing and reductive reactions on the topmost layer are in equilibrium.

Furthermore, the invention is realized in a method for operating a reflective optical element for the extreme ultraviolet up to the soft x-ray wavelength range comprising a multilayer system with a topmost cap layer consisting of carbon and/or an oxide in a closed system having a residual gas atmosphere comprising a reductive gas fraction and an oxidizing gas fraction, wherein the partial pressures of the gas fractions are adjusted in such a way that oxidizing and reductive reactions at the topmost cap layer are in equilibrium, and a lithography apparatus with at least one such optical element for the extreme ultraviolet up to the soft x-ray wavelength range consisting of a multilayer system with a topmost cap layer consisting of carbon and/or an oxide, wherein at least one layer- or cap layer thickness is chosen in such a way that during irradiation at the operating wavelength a standing electromagnetic wave is formed in such a way that it forms an intensity minimum in the area of the free interface of the optical element, with an evacuable housing in which the reflective optical element is arranged and at least two inlets which open towards the reflective optical element and are used for supplying an oxidizing gas or a mixture of oxidizing gases and a reductive gas or a mixture of reductive gases.

A further aspect of the invention is realized in an EUV-lithography apparatus with at least one photoelectron detector, with appropriate means for adjusting a residual gas atmosphere inside the EUV-lithography apparatus, and with at least one tunable monochromator in the optical path such that the incident wavelength can be varied, in particular switched between the operating wavelength and at least one usable wavelength. The switching between the operating wavelength and the at least one usable wavelength is preferably realized by a first reflective optical element with a maximum of reflectance at the operating wavelength and at least a second reflective optical element with a maximum of reflectance at the at least one useable wavelength, wherein the first and second reflective optical elements are preferably interchangeable with an operating reticle of the EUV-lithography apparatus. In a further development the EUV-lithography apparatus comprises a first photon detector for detection of photons at the irradiating wavelength and/or a second photon detector for detection of photons with higher wavelengths corresponding to photon energies below about 90 eV, including photon energies below about 1.65 eV, i.e. in the infrared wavelength range. The shifting from the irradiating wavelength to higher wavelengths is done by generating photons with specific wavelengths through controlling the standing electromagnetic wave being formed in the resonant case or by doping of a cap layer system of a reflective optical element for selectively generating photons with defined energies.

Yet a further aspect of the invention is realized in a method for operating such an EUV-lithography apparatus, wherein at predetermined times an irradiating operation is switched to a detection mode, in which

1. the location to be inspected is irradiated selectively and the photoelectron current and, if necessary, the reflectance are measured in dependence of the wavelength by tuning the monochromator;

2. the contamination state is identified through determination of the photoelectron current in the region of maximum reflectance, respectively, comparison on the measured photoelectron current data with data modelled for different contamination states.

Advantageous developments may be found in the dependent claims.

### BRIEF DESCRIPTION OF THE DRAWINGS

The invention is explained in closer detail with reference to the following figures. For this purpose show

FIG. 1a a manufacturing method for reflective optical elements;

FIG. 1b a modification of the method shown in FIG. 1a;

FIGS. 2a, b the basic principle of the method for determining the phase shift;

FIGS. 3a, b a first method for determining layer thickness;

FIGS. 4a, b, c, d a second method for determining layer thickness by measuring reflectance and photoelectron current for different carbon thicknesses, and oxidation, respectively;

FIGS. 5a-n spectrally resolved reflectance- and photoelectron current-curves computed for different carbon thicknesses as well as an intensity distribution of a corresponding standing electromagnetic wave being formed in the resonant case;

FIG. 6 a measurement arrangement for measuring the photocurrent and the reflectance;

FIG. 7 a draft of the design principle of a reflective optical element;

FIG. 8 an operating method for a reflective optical element;

FIGS. 9a, b measurement curves of photoelectron current and reflectance for different modes of operation;

FIG. 10 an EUV-lithography apparatus;

FIG. 11 a method for operating the EUV-lithography apparatus shown in FIG. 10;

FIGS. 12a, b, c spectral characteristics of the relative reflectance of reflective optical elements of the EUV-lithography apparatus shown in FIG. 10.

### DETAILED DESCRIPTION OF THE INVENTION

The manufacturing methods for multilayer systems with a cap layer system known so far suffer from that the determination of the thickness of different layers and cap layers, respectively, can be carried through only in a very imprecise way. In particular, only mean layer thicknesses over the depth of the entire multilayer system can be determined by reflectance measurements. However, this information is sufficient for optimization of the coating process of multilayer systems without cap layer system, as far as optimum reflectance is concerned. This problem is more serious in the production of multilayer systems with a cap layer system. The cap layer system breaks the periodicity such that no reliable information about layer thicknesses can be achieved by mere reflectance measurements. Sticking to the desired multilayer system as precisely as possible is extremely important for cap layer systems in terms of durability properties, in particular contamination resistance, while keeping reflectance as high as possible.

The measurement principle described herein is based on the fact that changes in the thickness of the cap layer system, which may consist of one or several layers, are resulting in large fluctuations of the photoelectron current on this coating whereas changes in reflectance are relatively small.

With the aid of methods and apparatuses according to the invention, it is possible by measuring the photocurrent to determine parameters transcending the parameters known from reflectometry. Thus, it is now possible to determine the phase shift of a standing wave formed in the case of resonance at the free interface of a multilayer system. This is important, in particular, in the case described above, i.e. when a cap layer system is located on the multilayer system for the purpose of protection against external influences such as input of energy and contamination. The customary measurement methods have not so far delivered adequate information relating to the phase adaptation of the cap layer system in relation to the periodic component in the form of the multilayer system. However, knowledge of this phase adaptation is absolutely necessary since both the achievable reflectance and the way it changes in the course of the service life, the photoemission and thus the degradation of the surfaces in the course of the service life, and also the wavefront and therefore the imaging properties in the course of the service life are substantially influenced by this phase adaptation.

One aspect of the invention serves the purpose of measuring optical elements and/or components of optical systems in the spectral range of extreme ultraviolet radiation or soft x-radiation. A preferred field of application is the measurement of optics for EUV radiation that achieve high reflectances in a narrow spectral range because of a coating with up to 100 or more layers with a thickness of a few nanometers that are made from alternating layers of different materials (for example molybdenum and silicon or molybdenum and beryllium). Such systems are applied in the field of EUV lithography. The spectrally and/or angularly resolved photoelectric characterization proposed here can be used for monitoring the production process and for quality assurance of the components in the EUV lithography system. In detail, the thickness of the cap layer of a reflective optical element and the spatial homogeneity thereof are determined in the shortest possible measurement period in a cost effective way and with the least possible complexity of apparatus by means of spectrally and/or angularly resolved photoelectric detection.

The spectrally resolved photoelectric characterization is carried out e.g. with the aid of an arrangement in which a radiation source divergently emits polychromatic EUV radiation and means are provided for collimation of the beam together with means for spectral dispersion. Furthermore, there is need for an electron capture apparatus with a current measuring unit for detecting the emitted photo-induced electrons, as well as a photon detector for measuring the reflectance. The object to be characterized is irradiated at a fixed angle to its surface during measurement.

By contrast, in the case of the angularly resolved photoelectric characterization, the object to be characterized is irradiated with a fixed wavelength, but at different angles. In a further variant, the measurement can also be carried out for specific combinations of wavelength and angle.

The phase shift of the standing electromagnetic wave is determined by virtue of the fact that the profile of the photoelectric current signal is determined in the region of maximum reflectance. In the region of maximum reflectance means in this case preferably in a region from −4% to +1%, in particular in a region from −3% to +1%, of the wavelength, or in a corresponding region of the angle of maximum reflectance. A starting premise in this case is that, to a first approximation, the photoelectron current is proportional to the intensity of the standing electromagnetic wave at the location of the free interface to the vacuum. If still further cap layers as for example topmost contamination cap layers are located on the multilayer systems, their outermost surface forms the free interface to the vacuum. In the general case, the phase shift of the electromagnetic wave is arbitrary at the free interface. However, the phase shift can be precisely determined via simultaneous measurement of the reflectance and the photon current.

Also based on the same principle is a method for determining the thickness of a cap layer system on a multilayer system. In a simple variant, the measured photoelectron current curve is compared with an already known photoelectron current curve. This can have been measured in advance on the same or a comparable sample (for example the same multilayer system, but a different cap layer system or different levels of contamination), or also have been ascertained by model calculations. The photoelectron current profile in the region of the maximum reflectance can be used to determine the respective phase shift with reference to the free interface, which corresponds to the respective spatial positions of the free interface in relation to the multilayer system. It is possible by forming the difference between the respective positions to determine the difference in thickness of the two samples or, given known layer thicknesses of the comparison sample, the cap layer thickness of the measured sample, specifically with a resolution of approximately 3 Å. In order to increase the accuracy of the thickness measurement to a resolution below 1 Å, the measured photoelectron current profile in the region of maximum reflectance is fitted to data modeled for various layer thicknesses.

In order to raise the information density, in particular during the production process or when maintaining reflective optical elements based on a multilayer system with a cap layer system, it has proved to be advantageous to carry out all steps in a spatially resolved fashion. During production, this information can be used to optimize the coating parameters, while during maintenance the reflective optical elements can be cleaned locally or their state can be monitored. In order to raise the accuracy, in addition to comparing the measured data with model calculations it is also possible for the said data to be compared with reference data which have been measured on the special multilayer system without resonance, or else with reference data that have been obtained on precisely specified multilayer systems.

The apparatus for carrying out the methods is distinguished in that a wide-angle element such as, for example, a wire grid or a wide-angle plate or even the wall of the vacuum chamber, is used as photoelectron detector. A maximum emission angle of the photoelectrons is covered thereby, and so a reliable signal is obtained even with low photoelectron currents.

Moreover, particular measures are taken to shape the beam spectrally or spatially. Normally the spatial beam shaping is performed via collimators, for example. The main requirements made on the beam in spatial respects are generally low divergence for a high angular resolution, or a beam spot as small as possible for a high spatial resolution. The spectral beam shaping is normally performed via monochromators, for example. It is possible for this purpose to make use, for example, of grid structures, film filters, specular reflectors or the like, particularly in the case of narrowband sources, for example, sources with a line spectrum. Tunable monochromators are preferred in the case of broadband sources, this being, for example, moveable grid structures, if appropriate in combination with a slit. Both the spatial and the spectral properties of the beam can be influenced with the aid of focusing monochromators. The spectral bandwidth of the monochromator should be as narrow as possible for measurements with a high energy resolution.

Given that the sample holder has three degrees of translational and rotational freedom, it is easier to carry out spatially resolved measurements at a fixed wavelength and/or fixed incidence angle, or a combination of specific wavelengths and angles. In particular, it is possible thereby to ensure more easily that the entire surface to be tested is scanned uniformly.

In a particularly preferred design, the apparatus has a device for applying an electric field in the vicinity of the sample. The photoelectrons can be accelerated onto the wide angle element with the aid of this electric field such that low-energy photoelectrons are also detected. This raises the measuring accuracy. It is, moreover, possible to shield ions that may be present so that they do not falsify the measurement result.

Laser-induced plasmas, discharge-induced plasmas and relativistic electrons come into consideration as radiation source, in particular for wavelengths between 1-20 nm. The synchrotron radiation resulting from relativistic electrons is distinguished by a broad energy spectrum in conjunction with low divergence. The two other radiation sources are particularly preferred because of their potential use on a laboratory scale.

The methods for determining the thickness of a cap layer system on a multilayer system described above can be advantageously used in a method for manufacturing a multilayer system with a cap layer system. Starting with coating designs and coating processes which have been optimized for multilayer systems before, it is sufficient to focus on the determination of the thickness distribution of the cap layer system, in case that these known multilayer systems are endowed with additional cap layer systems. The location of the maximum of reflectance is primarily determined by the design of the multilayer system as such, whereas the thickness of the cap layer system and its individual layers, respectively, determines the location of the free interface to the vacuum of the total system. Depending on the intensity which the standing wave actually reaches at this free interface, more or less photoelectrons are emitted. With common simulation programs, the intensities of the standing wave can be calculated for arbitrary designs. The data determined in such a way is compared with the desired coating design. If there are deviations, the coating parameters available, such as, among others, e.g. pressure, angle, currents, coating masks, movement patterns, and many more, may be adjusted accordingly and then a new coating process may be carried through. In terms of the optimization of the coating parameters, a spatially resolved measurement of the entire surface is highly important. Through comparison of the modelled data with the measured data, the thicknesses of the layers of the cap layer system can be determined precisely to the sub-Angstrom range

Depending on the use of the multilayer system with cap layer system and depending on the field of application of the multilayer system, respectively, it may be reasonable to provide a thickness distribution of the cap layer system which is constant across the whole surface or which is variable for compensating e.g. high thermal load, high local risk of contamination, or other.

Preferably, the production method is extended in such a way that the coating design is also optimized with its help, namely by testing multilayer systems with cap layer system obtained from simulations for optical systems in which the obtained multilayer system is included in a first pass, and then comparing the simulation results with predetermined specifications, e.g. concerning lifetime or imaging characteristics. In this respect, e.g., the variation of the contamination with the beam load or the intensity distribution in the beam being formed spectrally and geometrically by the multilayer system and optical system, respectively, may be of interest. Depending on the result, either the coating design is modified, a new optimization loop of the coating process is started, or it is found that the multilayer system with cap layer system meets the specifications.

The method may further be optimized by testing of the multilayer system during irradiating operation and comparing the test results with predetermined specifications. In doing so, the multilayer system may be measured as a single optical element e.g. in a measurement apparatus as described above, or as a component of an optical system. The latter is particularly recommended if simulations have been carried through for such an optical system beforehand. Again, depending on the result, either the coating design—if necessary, also the design of the optical system—is modified and a new optimization loop of the coating process is started, or it is found that the multilayer system with cap layer system meets the specifications.

In such a way, one will obtain all the important process parameters for the production, such that e.g. reflective optical elements for the extreme ultraviolet to soft x-ray wavelength range may be mass produced.

Particularly good results can be achieved if one uses an EUV source with as high a brilliance as possible, e.g. a synchrotron radiation source, or laser, or discharge-induced plasma source being optimized for small spot sizes of the beam, and one makes sure that the surface of the overall system is completely scanned. For the coating process itself, one may rely on any coating method as yet known, such as, e.g., electron beam vaporization, sputtering, in particular magnetron sputtering, or other.

In a particular embodiment, a reflective optical element for the extreme ultraviolet to soft x-ray wavelength range with a cap layer system of constant thickness across the whole surface is produced according to the principles described above. As mentioned already, one may either be limited to optimization of the coating parameters or may optimize the coating design itself—respectively also the layout of an optical system comprising the reflective optical element—as well. In doing so, an important aim of optimization is the maximization of the lifetime of the reflective optical element while at the same time ensuring a reflectance as high as possible at the operating wavelength.

For the production of reflective optical elements for the extreme ultraviolet wavelength domain, one advantageously starts with a multilayer system consisting of alternating molybdenum and silicon layers. As a rule, such a multilayer system is built up periodically. According to the specifications of the reflective optical element, it may also be appropriate to vary the periodicity or also the thickness of single layers of the entire multilayer system. One is not restricted to using two alternating materials as well. For example, intermediate layers, often called barrier layers, are frequently provided which avoid diffusion or intermixing of the individual layers, leading to a high a reflectance over a longer period of time.

The cap layer system is not built up periodically, but is optimized for protecting the multilayer system underneath from external influences as efficiently as possible. The main problem in this context is the contamination which may result in carbon deposits or oxidation of the surface.

Cap layer systems consisting of e.g. a layer of silicon, a layer of molybdenum, and a topmost silicon layer are highly preferable. During installation of the reflective optical element, or if it is only exposed to the ordinary ambient atmosphere, respectively, the topmost silicon layer is transformed at least partially to inert silicon dioxide and/or is covered with carbon by the ambient atmosphere. The layer thicknesses of the silicon-molybdenum-silicon cap layer system are chosen in such a way that after growing of a silicon oxide layer and/or a carbon layer, a reflectance as high as possible is still obtained. Further preferred cap layer systems are based upon transition metals. Especially preferred are gold, platinum, rhodium, ruthenium, palladium, silver, rhenium, osmium, and/or iridium, in particular on top of molybdenum-silicon multilayer systems.

The use of reflective optical elements produced for EUV-lithography apparatuses in such a way leads to EUV-lithography apparatuses with a high lifetime. The reflective optical according to the invention element may be arranged at arbitrary positions inside EUV-lithography apparatuses, such as in the illumination system or in the projection system. This holds for all reflective optical elements described herein.

Up to now, the cap layer system of multilayer systems for reflective optical elements for EUV-lithography is typically optimized with respect to maximum reflectance. Here, it is distinguished between two main types of designs. In the so-called “capped coatings” the cap layer system consists of e.g. a molybdenum layer and an oxidation-resistant layer preferably made of gold, platinum, rhodium, ruthenium, palladium, silver, rhenium, osmium, and/or iridium as a terminating layer. In the so-called “uncapped coatings”, the cap layer system as a rule consists of a silicon layer with a thickness of about 2 to 3 nm and a silicon oxide layer with a thickness of about 1 to 2 nm as a terminating layer, where this silicon oxide layer is normally not applied on purpose, but is formed automatically after the coating process by oxidation of the silicon layer, e.g. through removal into the atmosphere or during the set-up.

If one tries to optimize multilayer systems with a cap layer system also in terms of reduced contamination, two approaches have been followed so far. Particularly for the so-called “uncapped coatings”, it has been tried to choose the individual layer thicknesses in such a way that the minimum of the intensity of the standing electromagnetic wave being formed at the operating wavelength is located directly at the free interface. There, it is presumed that in this way only a minimum of photoelectrons will occur, which would otherwise cause a higher reaction rate between radiation, residual gas atmosphere, charged particles, and the surface. A further approach for reducing, respectively, avoiding contamination in “capped coatings” consists in controlling the ratios of reductive and oxidizing gases, e.g. hydrocarbons, oxygen, and water, in the residual gas atmosphere as well as the material at the free interface, in particular transition metals, in such a way that during irradiating conditions an equilibrium state is generated so that a negative influence on the stability and reflectance of the coatings is achieved. Such an equilibrium state is reached under irradiating conditions in the residual gas atmosphere by incorporating some additional oxygen into the topmost transition metal layer and depositing some additional carbon thereupon. With a loss of reflectance of about 1%, an equilibrium state is reached after a few minutes which varies only within these limits during the whole lifetime.

In those multilayer systems whose cap layer system comprises one or several transition metals, it has turned out that the equilibrium state mentioned before is most stable when the intensity maximum of the standing electromagnetic wave being formed is located in the range of the free interface. Probably, the described contamination suppression process does not only depend on an appropriate combination of residual gases consisting of reductive and oxidizing gas fractions, such as e.g. hydrocarbon, oxygen, and water on the one hand and a metallic, probably catalytically active surface of the cap layer system on the other hand, but also on the existence of reaction-stimulating free electrons. The positioning of the maximum of the standing wave in the vicinity of the free interface causes that a maximum number of reaction-stimulating electrons is always present.

In a preferred embodiment, the cap layer design is chosen in such a way that the free interface is somewhat withdrawn relative to the intensity maximum before the set-up. During the set-up in a residual gas atmosphere with hydrocarbon, respectively, through storage of the reflective optical element under atmospheric conditions over a time span of several weeks, carbon is deposited on the surface. By arranging an equilibrium state between processes of oxidation and degradation of the surface on the one hand, and reduction and adsorption of carbon on the surface on the other hand, an equilibrium state is generated which results in a carbon layer being just as thick so that the intensity maximum of the standing electromagnetic wave is located exactly at the free interface. By readjusting of the partial pressures, the preparation of this equilibrium may be speeded up. The contamination state is controlled through in-situ measurements of the photoelectron current and the reflectance, respectively, of the reflective optical element. Instead of measuring the reflectance simultaneously, one may rely on reflectance curves being calculated with the knowledge of designs of the multilayer system. In any case, by the presence of a carbon layer, the risk of degradation of the surface by unwanted oxidation reactions is also reduced.

A further advantage of the initial carbon deposition lies in the fact that the carbon is not only accumulated on the topmost layer, but also in the surface range of the matrix of the topmost layer. On the one hand, this avoids further permeation of oxygen and therefore further oxidation of the surface. At the same time, the incorporated carbon itself is largely protected against removal, e.g. through oxidation, because of the strong binding to the matrix. Carbon that is removed nevertheless is continuously re-supplied through the high fraction of hydrocarbons in the residual gas. Excess carbon in the matrix of the surface is continually removed, on the other hand, because of the high fraction of oxidants, such as water and oxygen, in the residual gas.

The overall result is that although contamination processes in the form of carbon accumulations do always occur, this does scarcely lead to a degradation of the reflectance since the adsorption of carbon on the surface matrix of a cap layer system based on transition metals takes place only in the sub-Angstrom thickness range in some sort of passivation process. Therefore, neither the mass density is increased nor the free interface is shifted in a significant way.

In the case of oxidation, a shift of the free interface will also not occur, yet an incorporation of oxygen, particularly in deeper regions of the surface matrix will occur, which lead to and increased mass density and thereby to an increased absorption. The additional incorporation of some oxygen in the topmost transition metal layer has the advantage that in such a way further incorporation of oxygen can be avoided.

In the case of reflective optical elements with topmost cap layers consisting of an oxide and/or carbon, it has also be shown to be advantageous to operate these in a residual gas atmosphere in which reductive and oxidizing reactions on the surface are balanced, especially the deposition of carbon and the formation of an oxidation layer, e.g. through addition of oxygen, hydrogen and at least one hydrocarbon, such that no considerable losses in reflectance may occur even over long operating times. Preferably, the coating design is indeed optimized in such a way that the standing wave being formed in the resonant case develops an intensity minimum at the free interface. In such a way, as few as possible electrons are provided at the surface, resulting in an overall attenuation effect of the reactions which take place at the surface. In such a way, it is made sure that no considerable contamination can take place.

The lifetime of EUV optics can be attained not only through optimization of e.g. the coating design as described above, but also through an amelioration of EUV-lithography apparatuses as a whole with regard to in-situ control, cleaning and also repair. In accordance with the invention, it is proposed that the EUV lithography apparatus comprises at least one photoelectron detector in addition to the usual elements such as e.g. optical elements. The latter may also be an ampere meter being connected to the reflective optical element via a cable. A supplementary photon detector may also be provided for a simultaneous measurement of reflectance, if it is not relied on reflectance curves calculated with the knowledge of multilayer system designs. Furthermore, means for adjusting a residual gas atmosphere inside of the EUV-lithography apparatus should be present, as well as at least one tunable monochromator. A tunable monochromator may e.g. consist of a grating of a condenser system of an EUV-lithography apparatus being mounted in a rotatable way. By adjusting the monochromator, e.g. through rotation of the grating, the angle of incidence changes and thereby the wavelength of the radiation inside the EUV-lithography apparatus is changed. It is preferred if it is not only possible to switch roughly between two angles of incidence, but if an angular region can be covered in as small as possible steps.

With the help of these components, switching to the so-called detection mode is possible at predetermined times, which can be stored in a control computer in the course of an overall automation of the EUV-lithography apparatus. For avoiding a negative influence on the areas to be inspected inside the lithography apparatus, e.g. mirrors to be inspected, the residual gas composition may be optimized at least in the region to be inspected. If a residual gas mixture with a reduced amount of contaminants is used, e.g., consisting of hydrocarbon, water, and oxygen, it should be taken care of the fact that the relative ratios of the fractions of the constituents are maintained in such a way that the equilibrium with a reduced amount of contaminants is maintained. The region to be inspected is irradiated selectively, and through adjusting of the monochromator the photoelectron current, respectively the reflectance, are measured in dependence of the wavelength in the respective region. From the determination of the spectral characteristics of the photoelectron current and the reflectance and/or the comparison of the measured photoelectron current with the data modelled for different contamination states, the contamination state can be determined (detection mode). Through this in-situ inspection, the operation state of the EUV-lithography apparatus may be determined with minimal effort.

The method may be extended in such a way that if first control parameters are exceeded, e.g. particular characteristics of the photoelectron current curve, which indicate an increased contamination, the residual gas atmosphere is modified in such a way that the contamination is reduced (cleaning mode). In addition, the incident light beam can be used for photocleaning of the respective optical element, e.g. by modifying the beam with respect to its cross section and/or position. The light for photocleaning may as well be provided by a second light source of the same wavelength used during operation for the EUV lithography apparatus or of another wavelength suitable for removing contaminations, such as for example DUV light.

By exceeding of second control parameters, e.g., also particular characteristics of the photoelectron current curve which point to defects on the surface, not only the residual gas atmosphere in its composition is modified, but also the incident beam with respect to its cross-section and its position, so that material can be deposited and/or removed in a spatially defined way (repair mode). In the detection and cleaning mode operating with a spatial resolution is preferable, too.

It may be useful to change partial pressures inside the lithography apparatus, at least at the irradiated spot, in the detection mode, the cleaning mode and/or the repair mode in order to avoid unwanted effects such as e.g. too strong oxidation.

It may further be of use in the detection mode, cleaning mode and/or repair mode to switch from the normal operating wavelength to a different usable wavelength with the help of a monochromator. The background of this is that different wavelengths cause different photo electron currents because of a different phase shift of the standing wave formed due to reflection, and, using the overall wavelength spectrum available in the EUV-lithography apparatus for detection, repair and/or cleaning purposes, these may be used selectively.

As additional tools, a cleaning reticle, an appropriate collimator and/or apertures may be used for this purpose. In contrast to the usual operating reticle, the specific cleaning reticle is normally optimized in such a way that it generates the desired illumination at the spots to be inspected inside the projection system in terms of spatial and spectral properties. To this end, the reticle may also be combined with appropriate apertures. During a scan of the cleaning reticle, e.g., the whole surface of the region to be inspected is scanned with a small irradiating spot in an analogous way as in a Braun tube. At the location of the irradiating spot, the detection as well as the cleaning and the repair can be performed in a spatially localized manner.

Also with the help of appropriate collimators and apertures, the size, position and/or wavelength, respectively, bandwidth of the irradiating spot may be changed through an appropriate adjustment. In particular, a collimator may be considered for control measurements in the illumination system for beam forming. An aperture may be used in the illumination system as well as in the projection system. Collimators and apertures may also be used in conjunction. In particular, in conjunction with the at least one adjustable monochromator, which preferably is provided with a mechanism for stepless adjustments of position and size, bandwidth, and wavelength of the radiation used for detection, cleaning, and repair, may be adjusted in a stepless way. Thereby, the intensity of the usable radiation may also be varied.

For detection of photons in the reflectance measurement, preferably a commonly available semiconductor detector is used. For the detection of the photoelectrons, the location to be inspected has to be conductively connected to an electron collecting device. The electron collecting device may be e.g. a grating, a metal ring, or a metal cylinder. It is also possible to use the wall of the EUV-lithography apparatus for this purpose, in particular when for the separation of different functional units, such as the projection system or the illumination system, partition walls are present.

The existence of partition walls may also be used for selecting residual gas atmospheres adjusted in dependence of the conditions being present in the respective partitions. One may also go so far as to include each optical element in a single compartment. The individual mirror compartments may then be separated in the optical path e.g. by optical foil filters. Furthermore, the interior of the mirror compartment is connected with the environment through valves. The environment may be either the atmosphere of another mirror compartment, or the atmosphere inside the EUV-lithography apparatus, or also a direct gas supply from the exterior. Through clever arrangement of valves, gas inlets, gas outlets, or other, it may also be achieved that pressure differences inside the surface of a reflective optical element arise. This is particularly advantageous in the cleaning and the repair mode.

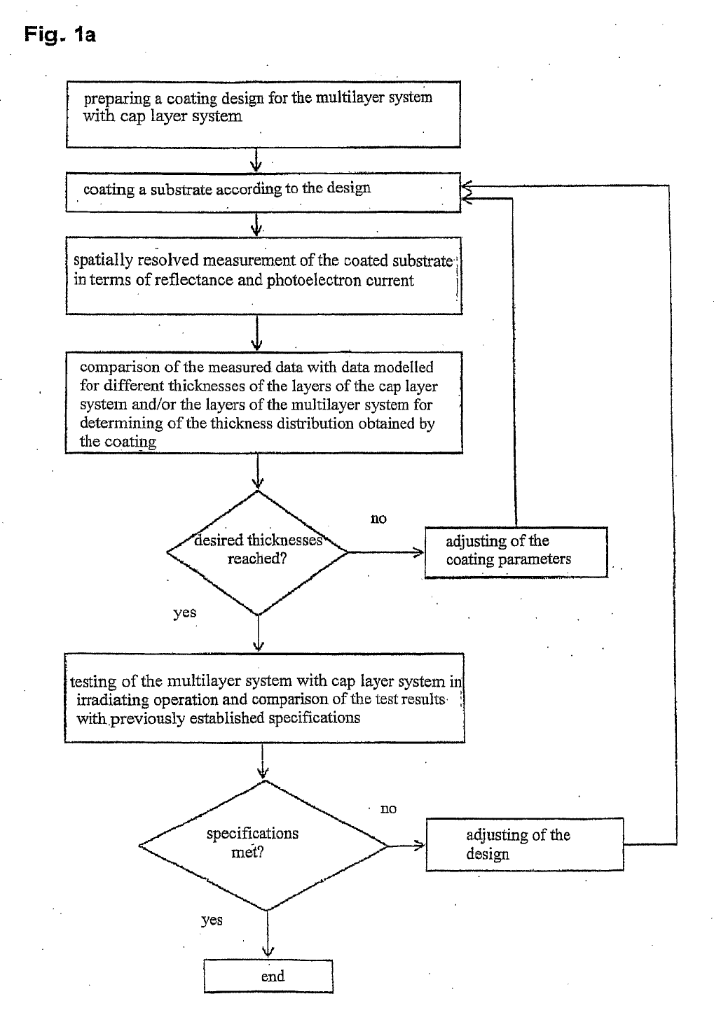

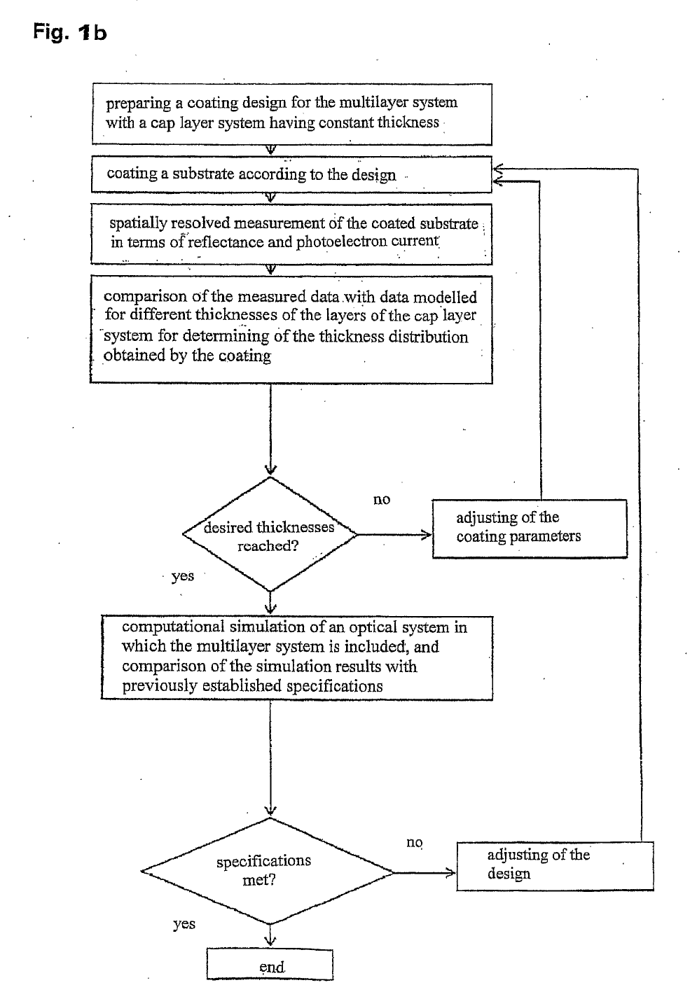

In FIG. 1a, the production method for reflective optical elements for an EUV-lithography apparatus is exemplified. One starts with preparing a coating design which satisfies theoretical specifications e.g. for the use as a mask or a mirror in the illumination optics or the projection optics and, among other things, may have a cap layer and/or multilayer system with a variable thickness distribution over the surface. The multilayer system and the cap layer system may be applied onto a substrate in a way known as such, e.g. by electron beam vaporization or magnetron sputtering. The coated substrate is measured in terms of reflectance and photoelectron current, and the thickness distribution is calculated. The simultaneous measurement of reflectance and photoelectron current is performed either with dispersion of angle or energy, or with specific combinations of angles and energies. If the desired thickness is reached, the fully coated reflective optical element is inspected by a further synchronous measurement of the reflectance and the photoelectron current. In this way, the design itself can be optimized by testing the reflective optical element in irradiating operation and/or in a simulation of an optical system with respect to fulfilment or non-fulfilment of certain specifications. If necessary, the coating design is adjusted and then a new coating process is carried out which is tested as explained above. If the design as well as the coating process are optimized, one may start with the mass production of the desired reflective optical element based upon the now established optical coating parameters.

According to the method described above, any kind of thickness distribution may be produced. In a preferred embodiment, one produces a reflective optical element based upon an already tested multilayer system whose production process is already well-controlled. In this case, the reflective optical element further comprises a cap layer system with a thickness distribution being constant over the surface (see FIG. 1b). During the determination of thicknesses, one focuses on the thicknesses of the cap layer. As a variant of the method shown in FIG. 1a, in this case the multilayer system is not tested in real irradiating operation, but simulations of an optical system are carried through in which the multilayer system with cap layer system is used. The results are compared to specifications established beforehand in order to decide whether or not the layer design has to be further adjusted. In a modification of this method shown in FIG. 1b, further optimization loops may be envisaged in which the multilayer system is tested separately or as a component of said optical system during actual irradiating operation.

In the following, the simultaneous measurement of the reflectance and of the photoelectron current for determining the thickness distribution which is used e.g. in the methods shown in FIG. 1, is described in more detail. The free interface, that is to say the topmost surface in relation to the vacuum, of a multilayer system is measured with radiation in the extreme ultraviolet down to the soft x-ray wavelength range. As a radiation source, any desired EUV source may be used, e.g. based on relativistic electrons as well as laser- or discharge-induced plasmas. Particularly accurate measurements can be obtained with well-collimated beams which lead to a small, intensive irradiating spot, which may be obtained e.g. by synchrotron radiation. The variable irradiating spot can be used to scan the entire coated surface such that two-dimensional phase shift and thickness distributions can be measured, and geometric coating parameters can also be precisely determined.

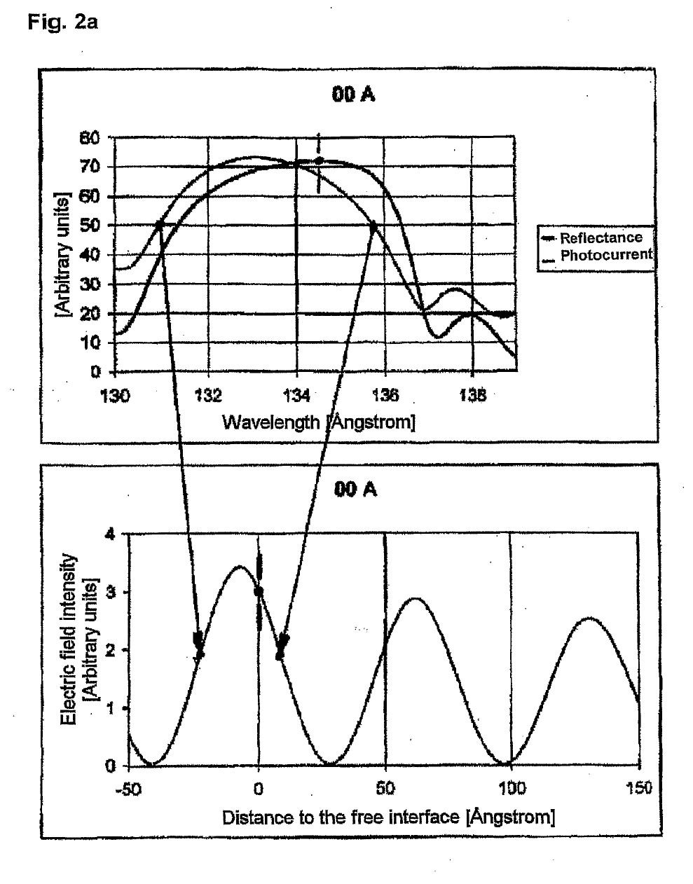

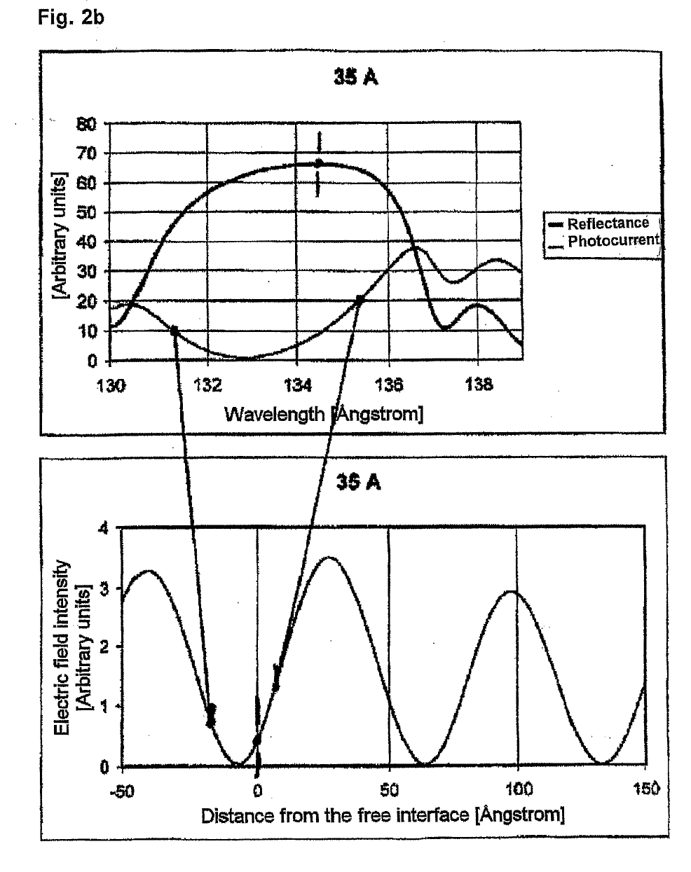

Two methods for determining the thickness distribution are described below, both relying on the principle for determining the phase shift of a standing electromagnetic wave in the extreme ultraviolet up to the soft x-ray wavelength range at the free interface of a multilayer system as illustrated in FIG. 2a. The first step is to define the position of maximum reflectance (marked in FIGS. 2a, b by a vertical dash point dash) that visualizes the position of the free interface. Lying to the left thereof is the vacuum, in the case of plotting against the wavelength, and to the right thereof are the cap layer system and the periodic component of the multilayer system. The profile of the photoelectron current curve is considered at a distance of −3% to +1% around the wavelength of maximum reflectance. If a maximum is located in this area (as in FIG. 2a), there is also a maximum of the intensity of the standing wave in the area of the free interface—corresponding to a minimum (as in FIG. 2b) or an edge (not illustrated). When the measurement curves are plotted against the wavelength in the way illustrated in FIGS. 2a, b, the profile of the photoelectron current curve corresponds to the profile of the intensity of the standing wave in the area of the free interface. There is lateral inversion when plotting this against energy. If angularly resolved measurements are carried out, the curve profile is similar to that in the case of wavelength-resolved measurements.

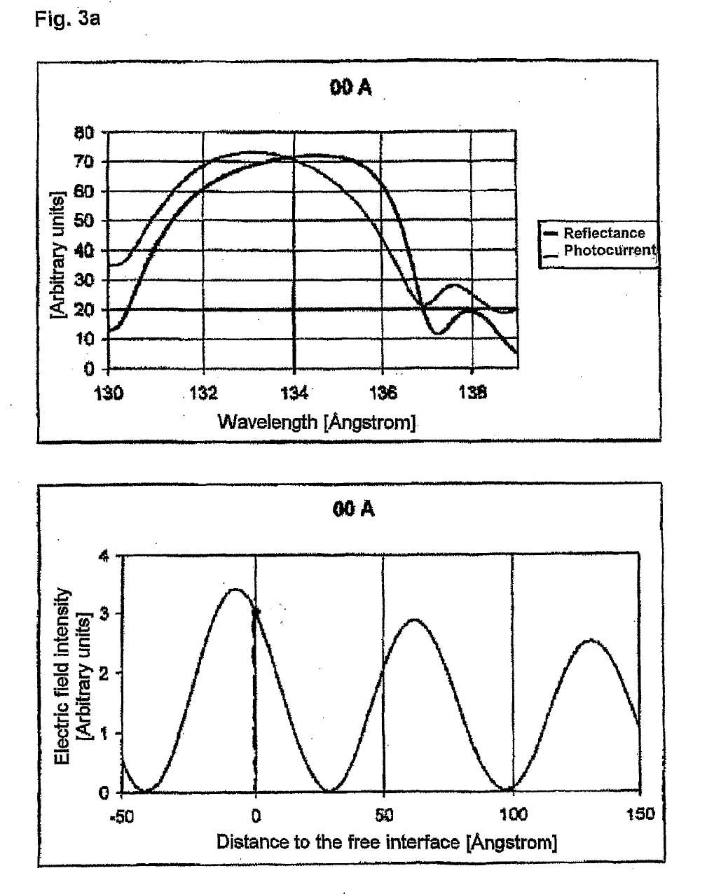

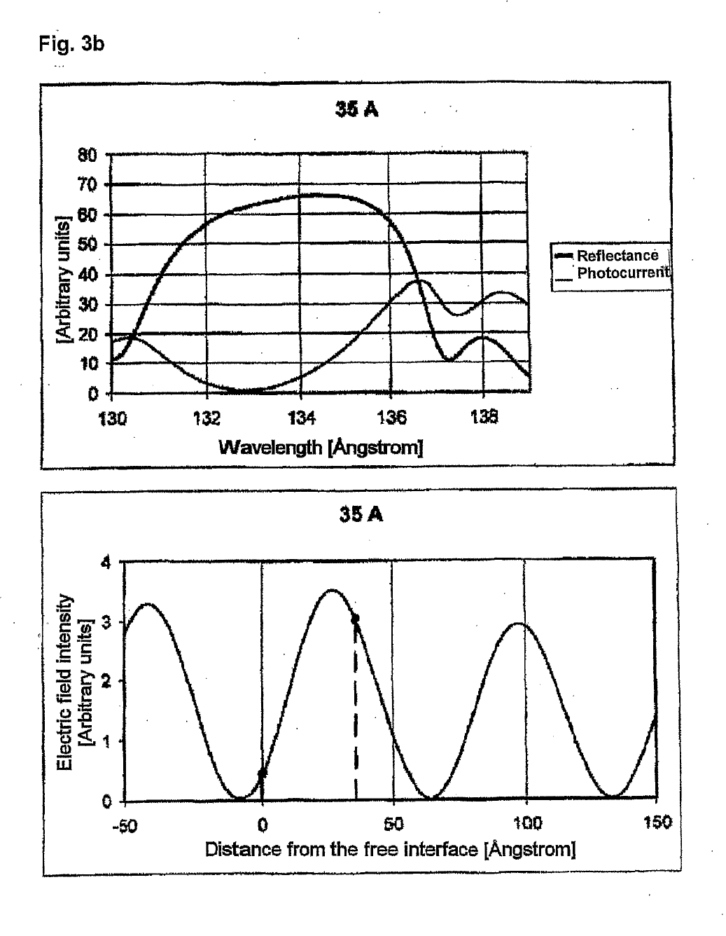

The first method for determining thickness is illustrated in FIGS. 3a, b: an uncoated or uncontaminated multilayer system is measured as described, and the phase shift of the intensity of the standing wave is determined with reference to the free interface as reference position with thickness d=0 Å. The coated or contaminated multilayer system is likewise measured. The thickness difference of 35 Å results in the present example from the difference between the first phase shift and the second phase shift. An accuracy in the Ångstrom range is achieved thereby.

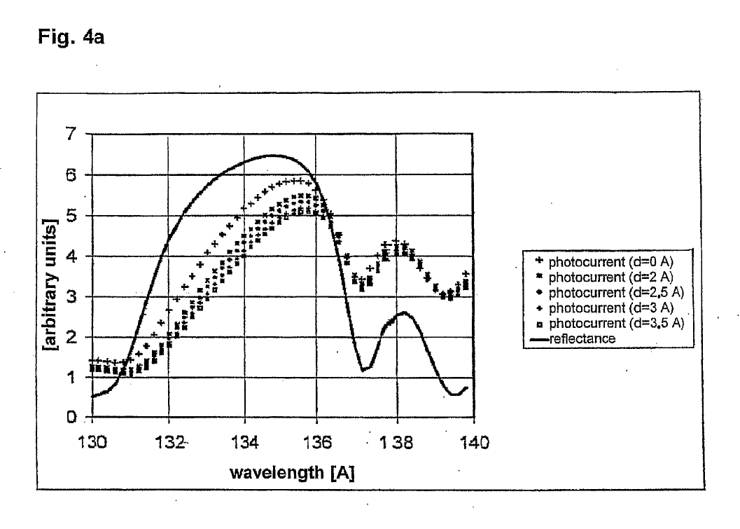

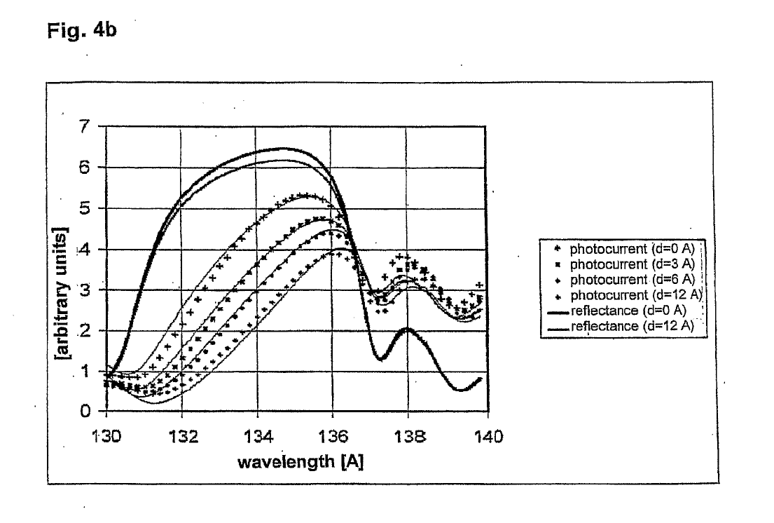

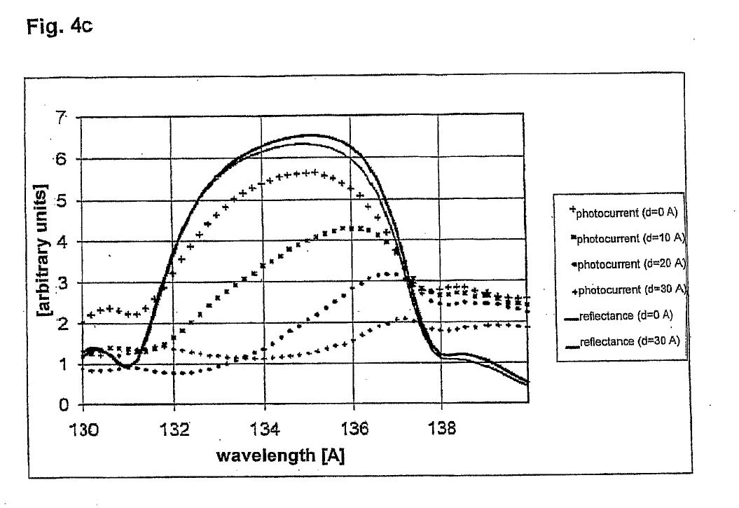

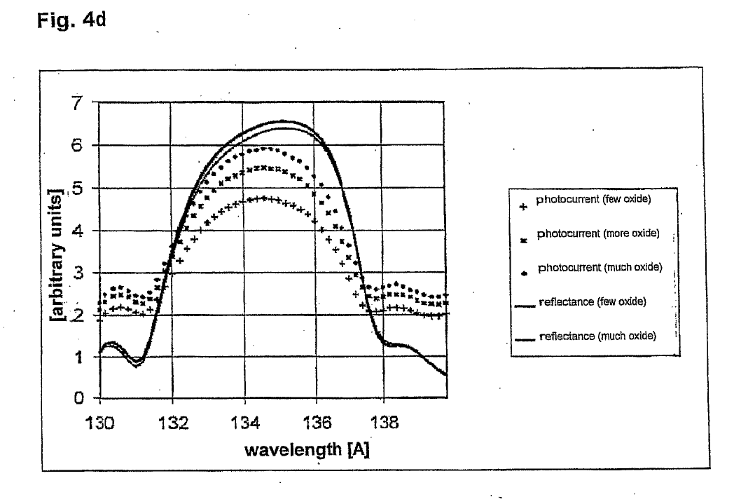

Should it be desired to determine the thicknesses accurately down to the sub-Ångstrom range, a second method for determining layer thickness makes use of photoelectron current curves modeled for different thicknesses and to which the measurement curve is fitted. The accuracy can be raised by introducing values from measurements in the absence of resonance, or else measurements on precisely specified multilayer systems into the calculation of model curves. In this type of thickness determination, use is made of the fact that differences in thicknesses are expressed only marginally in a change of the reflectance curve (see, for example, FIG. 4a for small carbon thicknesses, and FIG. 4b for thicker carbon thicknesses), but in significant changes of the photoelectron current curve.

FIGS. 4a, b, c illustrate by way of example the photocurrent curves measured by energy dispersion, and the partially corresponding modeled curves for small carbon thicknesses of 2 Å, 2.5 Å, 3 Å, 3.5 Å (FIG. 4a), 3 Å, 6 Å, 12 Å (FIG. 4b), 10 Å, 20 Å, 30 Å (FIG. 4c) or entirely without a carbon layer, in arbitrary units. The reflectance curves for the samples with the respectively thickest carbon layer and for the sample without a carbon layer are also illustrated for the sake of comparison. The pure measurement curves are illustrated in FIGS. 4a, c. The corresponding simulated curves are laid through the measured photoelectron current curve in FIG. 4b. All the photoelectron current curves are identically normalized, thus being true to scale. It is to be taken into account in this case that the calculated and measured photoelectron current curves differ systematically by a constant background in the form of a constant upward shift of the experimental curves. The reason for this is that a photocurrent greater than zero occurs for an escape depth of greater than zero even when the field strength is zero at the free interface. The escape depth, which depends on material and layer thickness, and similar effects can also influence the shape of the photoelectron current curve, and this is to be taken into account correspondingly in model calculations.

It is clearly to be seen, firstly, that the different carbon layers have only a slight effect on the reflectance, whereas changes in the photoelectron curve are very plain. Secondly, it can clearly be seen that because of this pronounced variation in the photoelectron current curve it really is possible to determine the thickness accurately down to the subångstrom range by fitting to modeled data.

In the case of mere oxidation according to FIG. 4d, no shift of the free interface can be observed. At the same time, the photocurrent increases significantly because of the absorption of radiation caused by the oxygen stored during the oxidation.

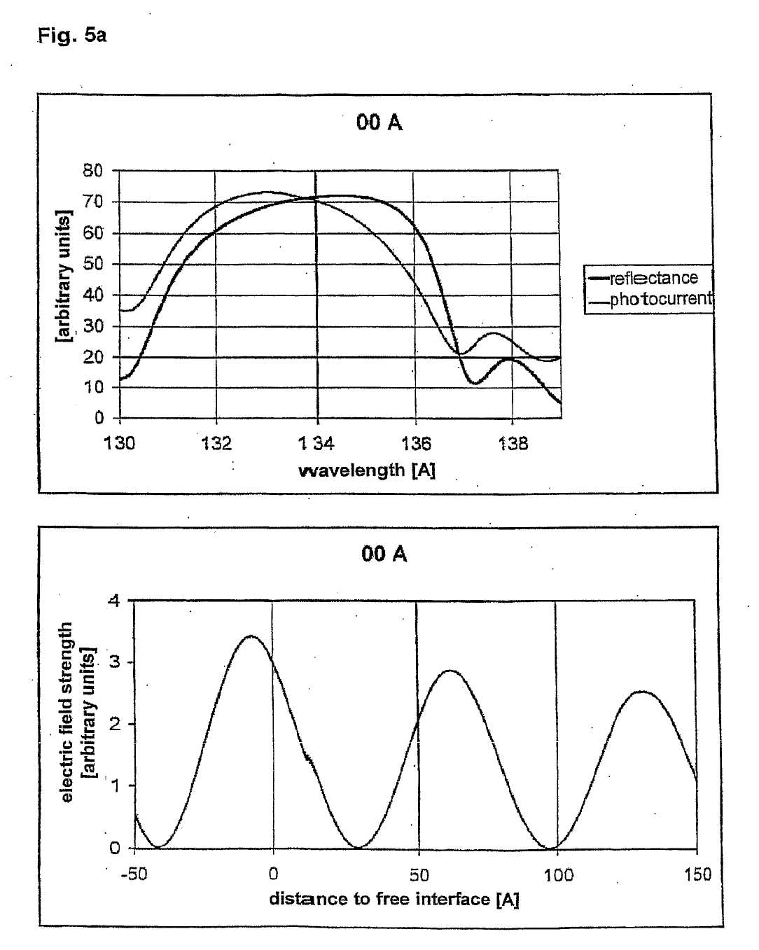

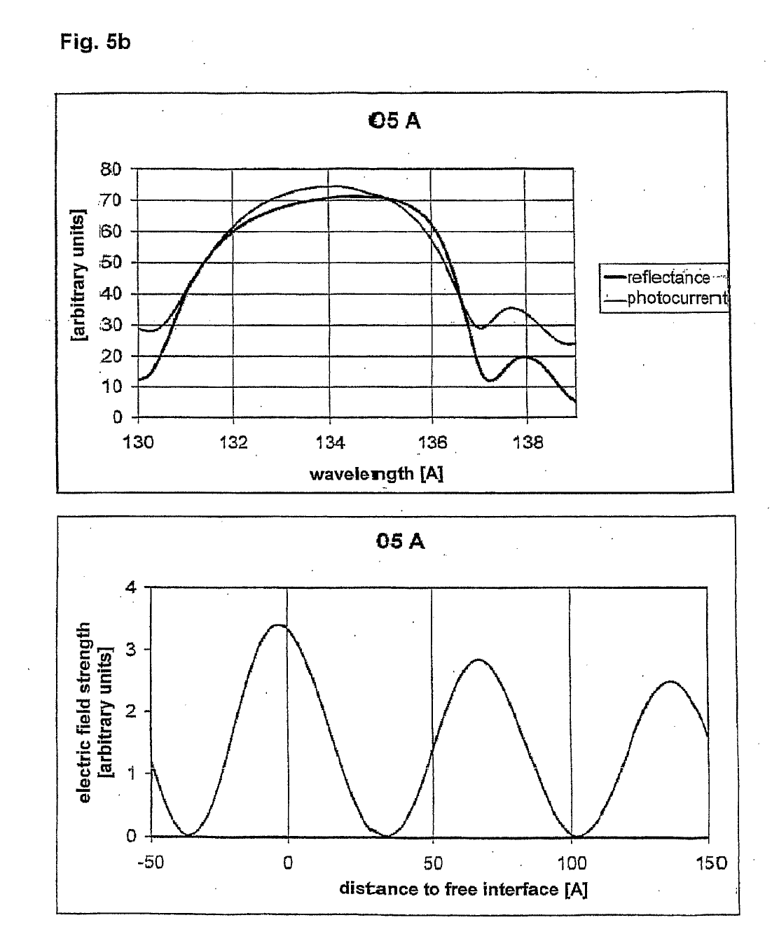

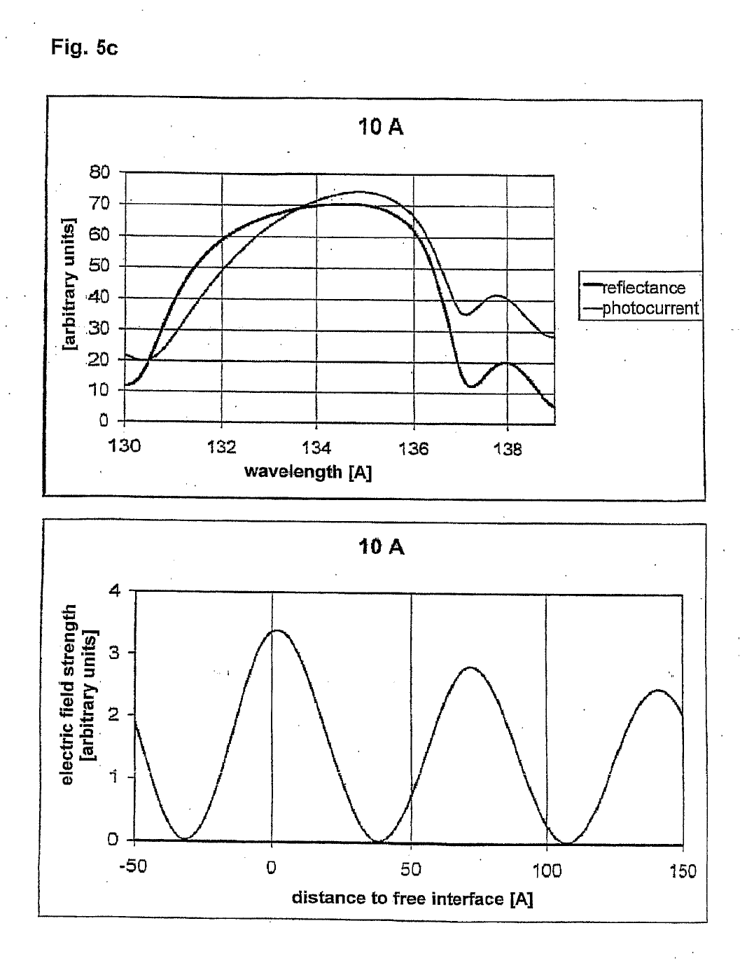

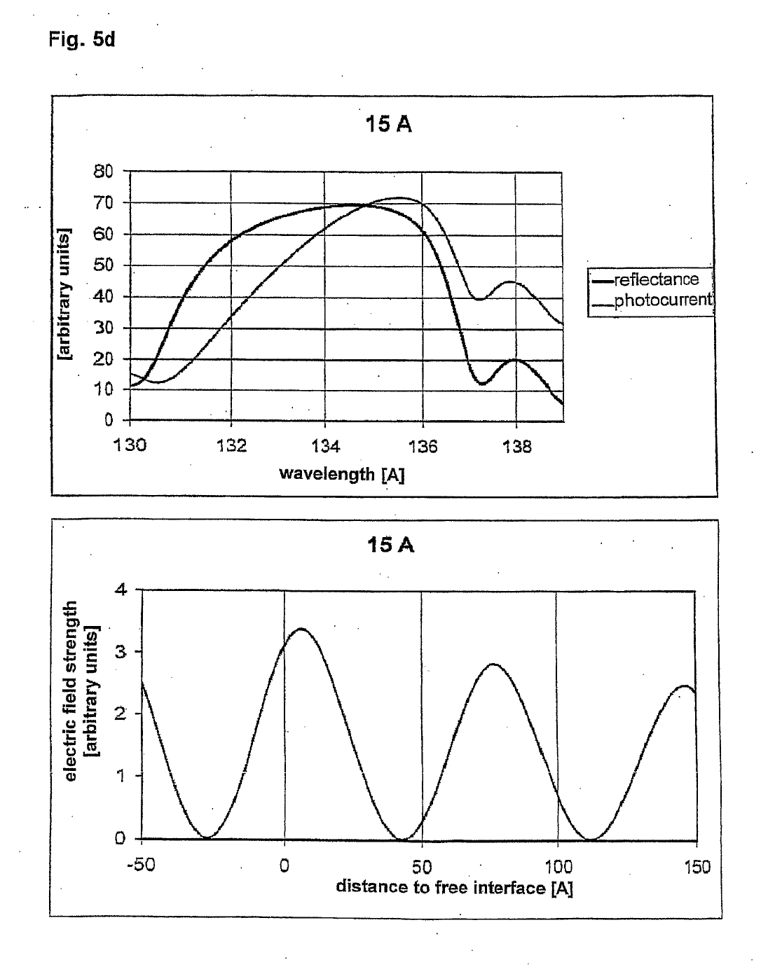

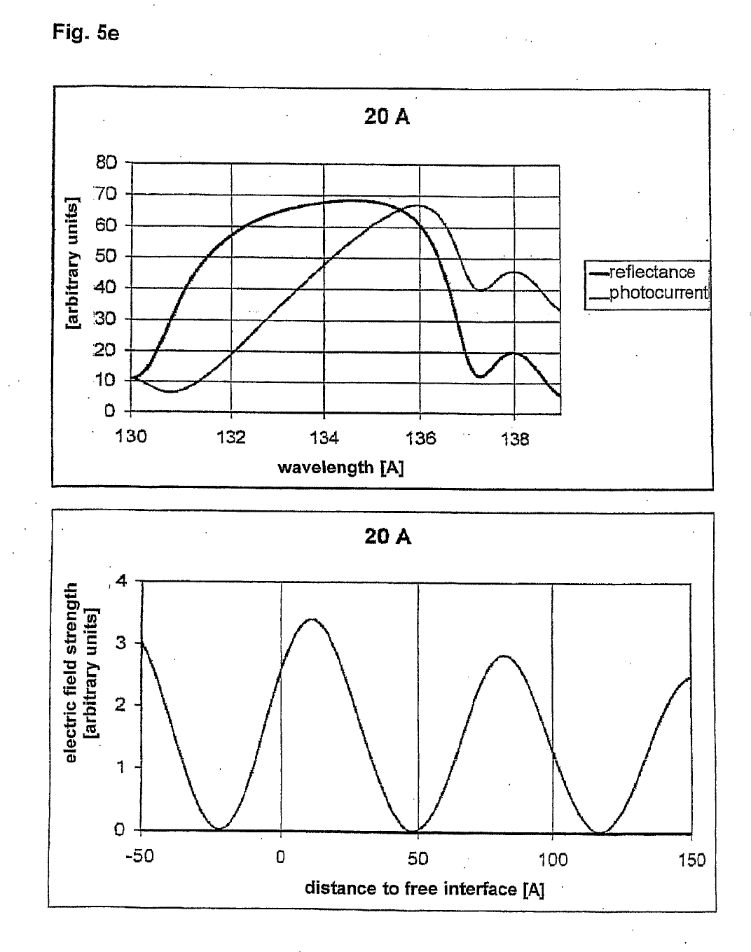

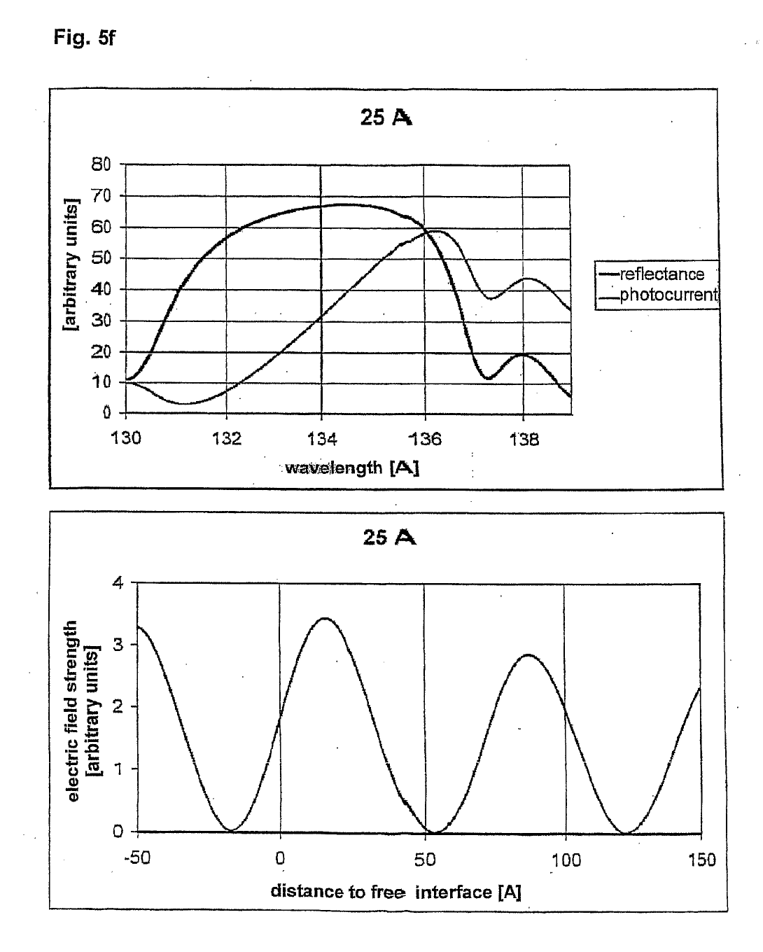

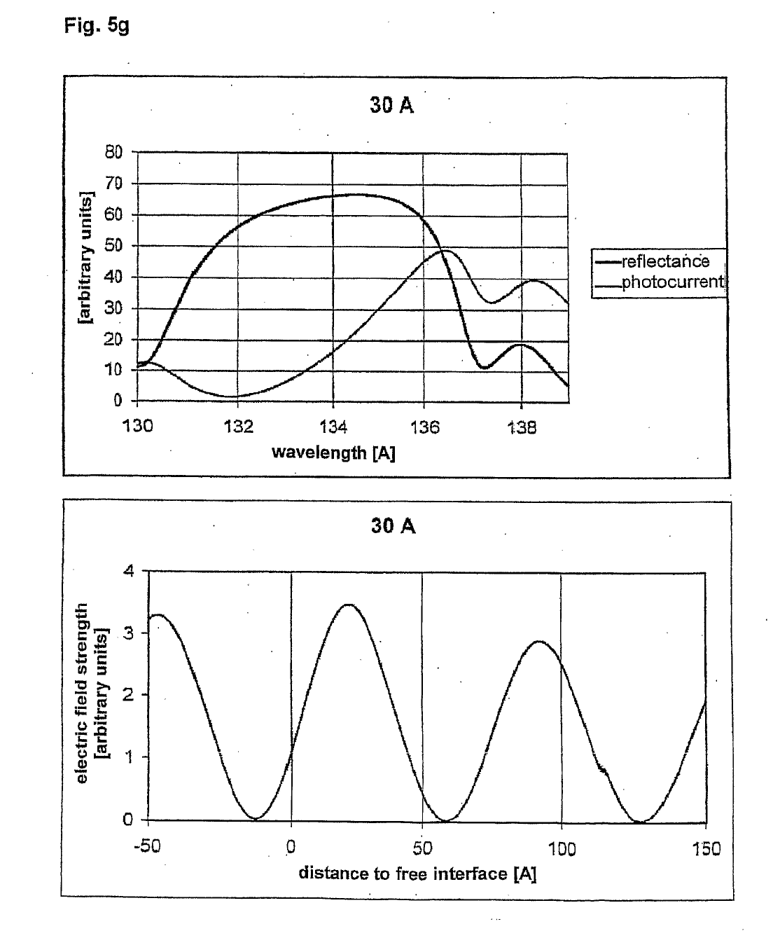

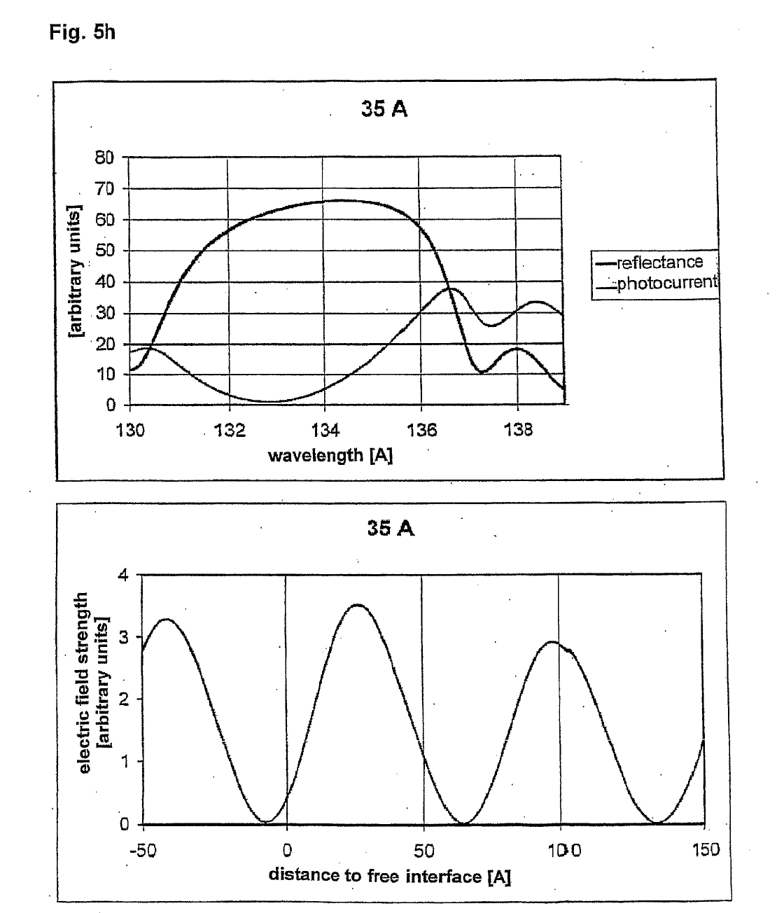

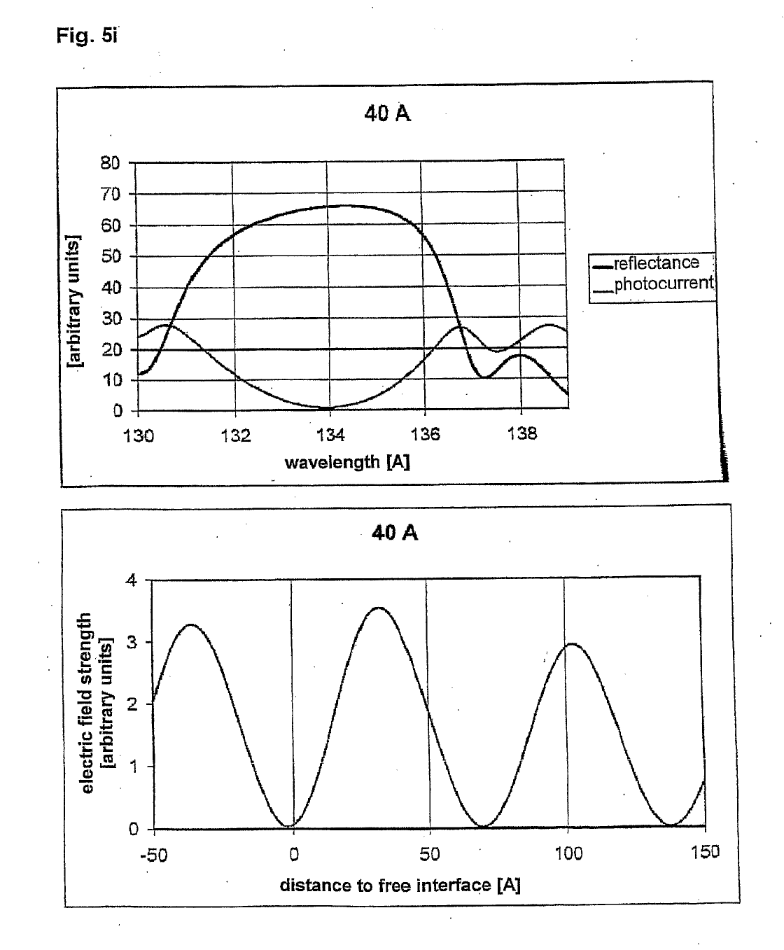

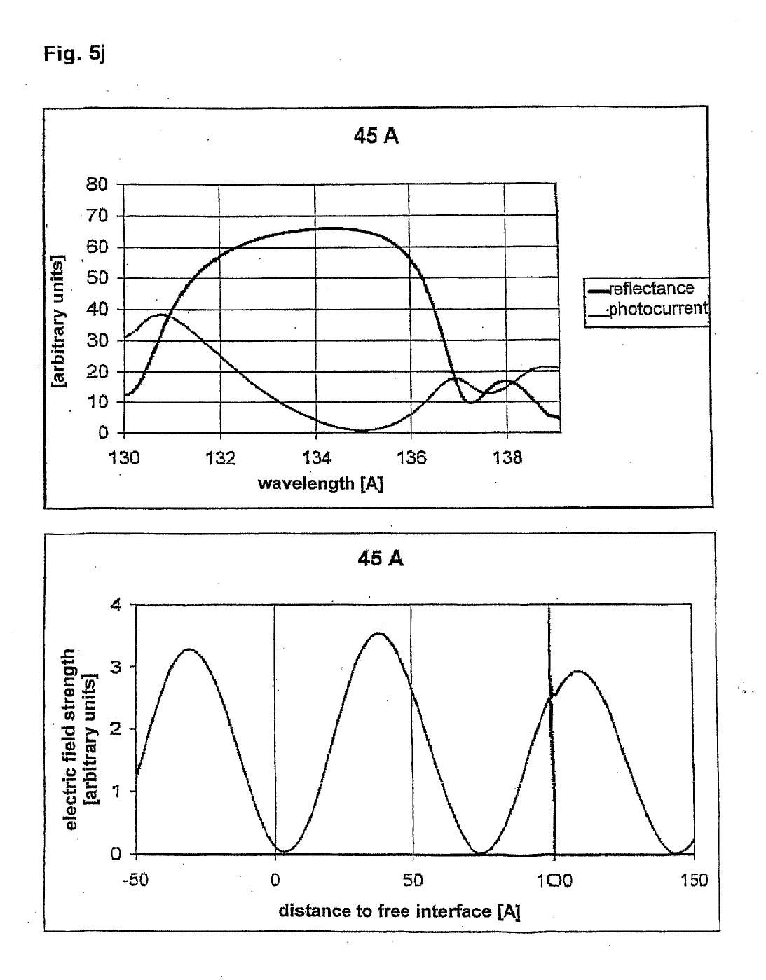

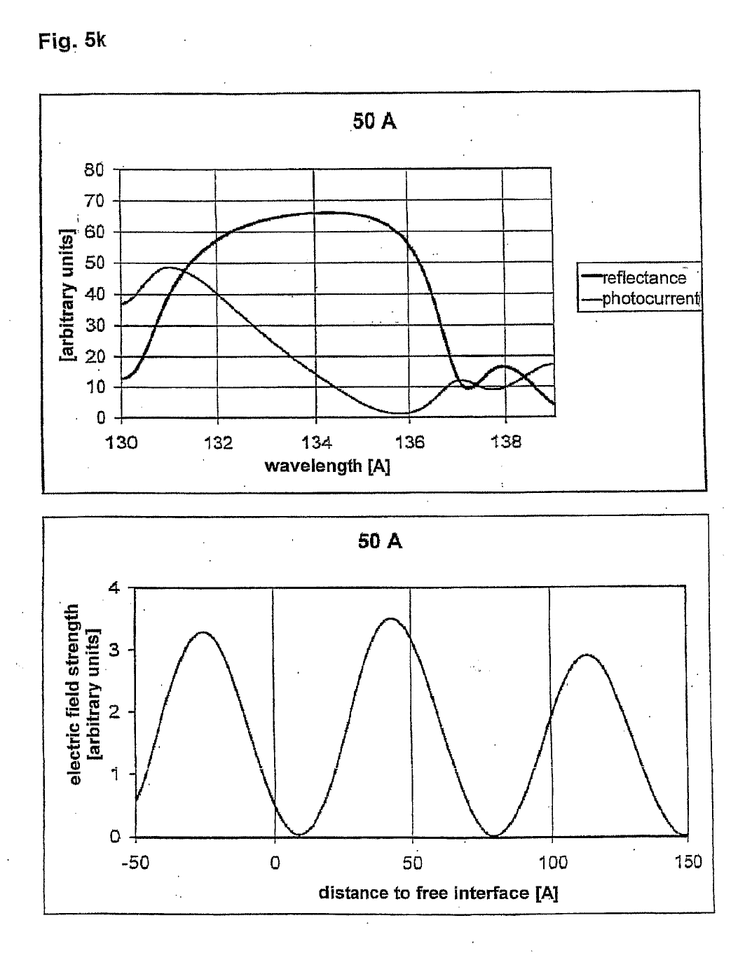

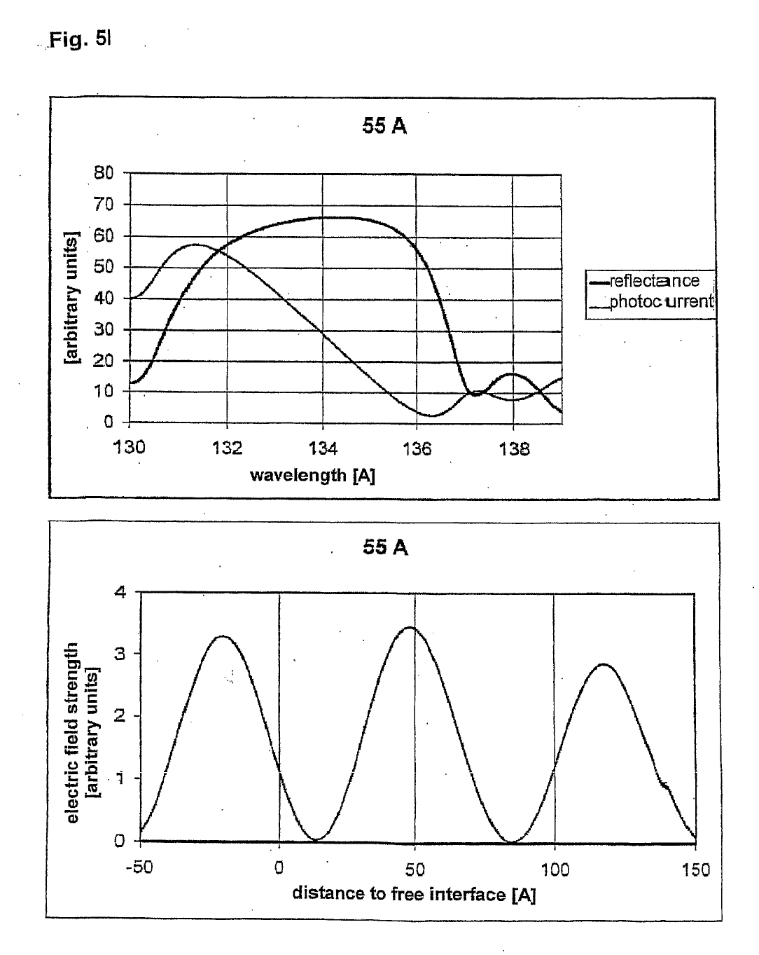

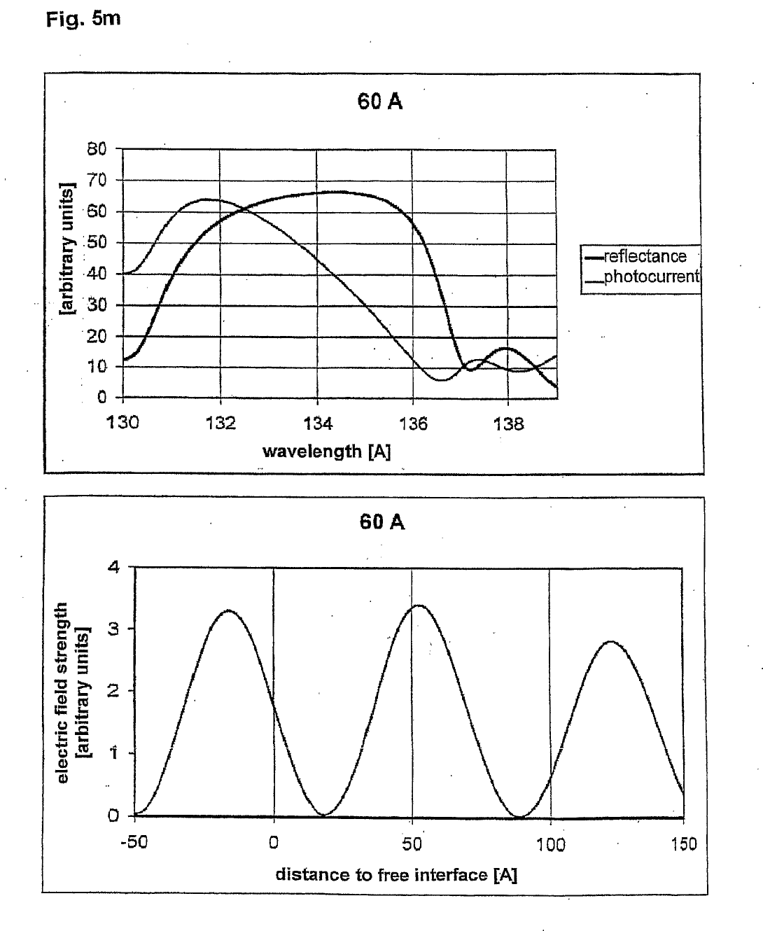

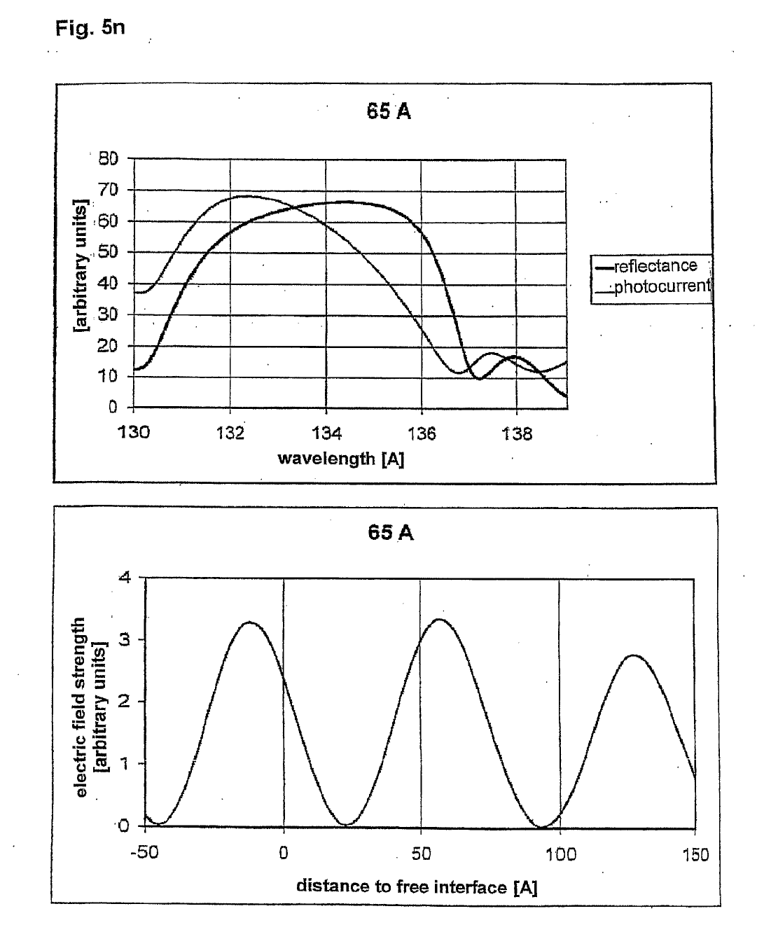

The calculated relationship between the profile of the photoelectron current curve in the area of maximum reflectance and the phase shift of the standing electromagnetic wave that is formed on the reflective optical element in the resonant case is illustrated with the aid of FIGS. 5a-n. Firstly, the simultaneously measured reflectance and photoelectron current curves are illustrated in the top half and, secondly, the spatial distribution of the intensity of the standing wave is illustrated in the bottom half of the figure, again in an exemplary fashion for carbon layers of thicknesses from 0 Å to 65 Å, arbitrary units being used.

The position of maximum reflectance is determined very predominantly by the molybdenum silicon multilayer system selected by way of example. The position of maximum reflectance is also determined to a slight extent by the topmost cap layer, carbon here, by way of example. The presence of a cap layer system composed, for example, of carbon and silicon or else ruthenium has an effect chiefly on the absolute value of maximum reflectance. The vacuum interface, here specifically the interface of the carbon layer to the vacuum, is denoted as free interface.

If the top and bottom halves of the figure are respectively compared, it is found that in the event of a constant position of the intensity of the standing wave relative to the multilayer system, there is a change in the position of the free interface with different carbon thickness such that the intensity of the standing wave at the free interface assumes different values for different carbon thicknesses. Low intensity values in conjunction with high carbon thicknesses are expressed in a minimum photoelectron current in the case of resonance, and high intensities in conjunction with low carbon thicknesses are expressed in a maximum photoelectron current in the case of resonance. It is clearly to be seen that the profile of the photoelectron current curve in the area of maximum reflectance corresponds to the profile of the intensity of the standing wave in the area of the free interface.

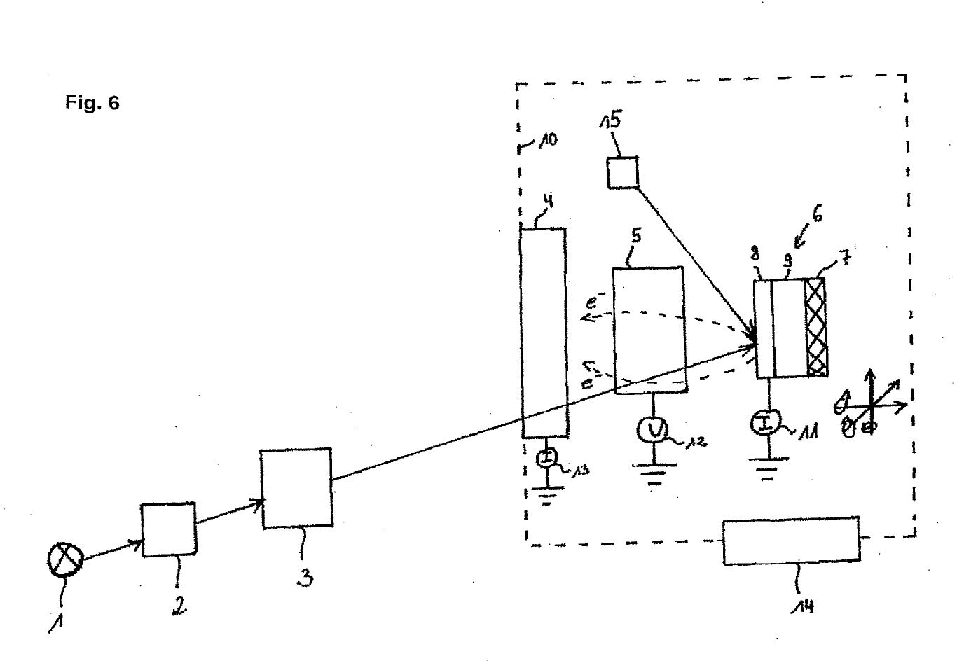

FIG. 6 illustrates the principle of the measurement setup for carrying out the methods for determining the phase shift and the layer thicknesses described above. The radiation emanating from a radiation source 1, illustrated by an arrow, strikes means for spatial and spectral shaping of the beam characteristic, these being a collimator 2 and a monochromator 3 here, by way of example. The radiation source is a radiation source for wavelengths in the range from 1 to 20 nm. Suitable for this purpose are, for example, laser-induced plasmas or discharge-induced plasmas, or else relativistic electrons.

The collimator 2 can serve the purpose of providing a measuring beam of low divergence at the sample location in order to ensure a high angular resolution, or else to provide a small beam diameter at the sample location in order to achieve a high spatial resolution.

The monochromator 3 serves primarily for selecting the measuring wavelength. It should be as narrowband as possible in order to ensure a high energy resolution. Particularly in conjunction with broadband radiation such as, for example, synchrotron radiation, a tunable monochromator is selected in order to carry out energy-dispersive measurements. In this case, the monochromator can be constructed, for example, as a moveable grating in combination, if appropriate, with a slit. Particularly in the case of radiation sources having a line structure, use is made of monochromators adapted thereto, such as fixed gratings, film filters or specular reflectors, for example.

Components 2 and 3 can also be of unipartite construction in the form of focusing monochromators.

The further components of the measuring apparatus are arranged in a vacuum chamber that is indicated by the dashed line 10. The sample 6 can be introduced via a load lock 14. The sample 6 comprises a multilayer system 8 on a substrate 9, and is fastened on an electrically insulated sample holder 7. This sample holder has three degrees of translational freedom and three degrees of rotational freedom, and so the entire surface of the sample 6 can be scanned with the aid of the measuring beam.

The beam striking the multilayer system 8 is reflected. The reflected beam is measured by a photon detector 15 for measuring reflectance. Moreover, photoelectrons induced by the incident radiation emerge from the multilayer system 8. These are indicated by dashed arrows. They are collected by an electron capture apparatus 4. The current induced by the incident photoelectrons is measured by an ammeter 13. The vacuum wall 10 or else a wide-angle plate or a wire grid, for example, can serve as electron capture apparatus.

In order to create defined electromagnetic relations between the sample 6 and the electron capture apparatus 4, a defined electric field is applied with the aid of component 5. The defined electric potential can be applied by a ring, a cylinder or a grid. In this case, the component 5 can be of arbitrary complex configuration and is connected to a voltage source 12. It is also possible, for example, for the sample itself to be set to a specific voltage in order to generate a defined electric potential.

It is preferred to use ammeters in which a specific phase voltage can be set. It is possible correspondingly to make use for component 5 of a voltage unit on which it is also possible to read out currents flowing at component 5.

The defined electric potential serves not only to direct the electrons onto the electron capture apparatus, but also, in particular, to shield the electrons and the electron capture apparatus from ions that may be present, in particular positively charged ions. The measuring accuracy of the photoelectron current curve is thereby raised.

In order to raise the measuring accuracy further, it is also possible to use an ammeter 11 to measure the current flowing in the multilayer system 8 when photoelectrons are emerging. Here, as well, it is possible to use a meter in which the voltage can also be set.

In a particular variant, there are arranged in the vacuum chamber 10 two or more samples 6 for which the current flowing at the samples is measured by connecting the samples in parallel and/or series with one another to the ammeter 11. The current flowing in one sample during measurement then flows, if appropriate, to the ammeter 11 via the other sample. This is possible because it is not absolute currents that are measured but only the spectral profile of the photoemission, which is influenced only by the incident radiation.

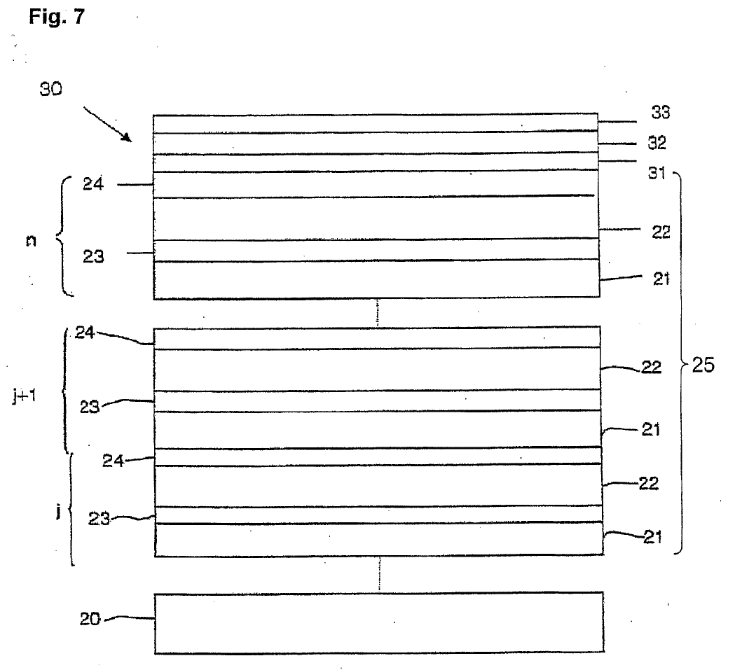

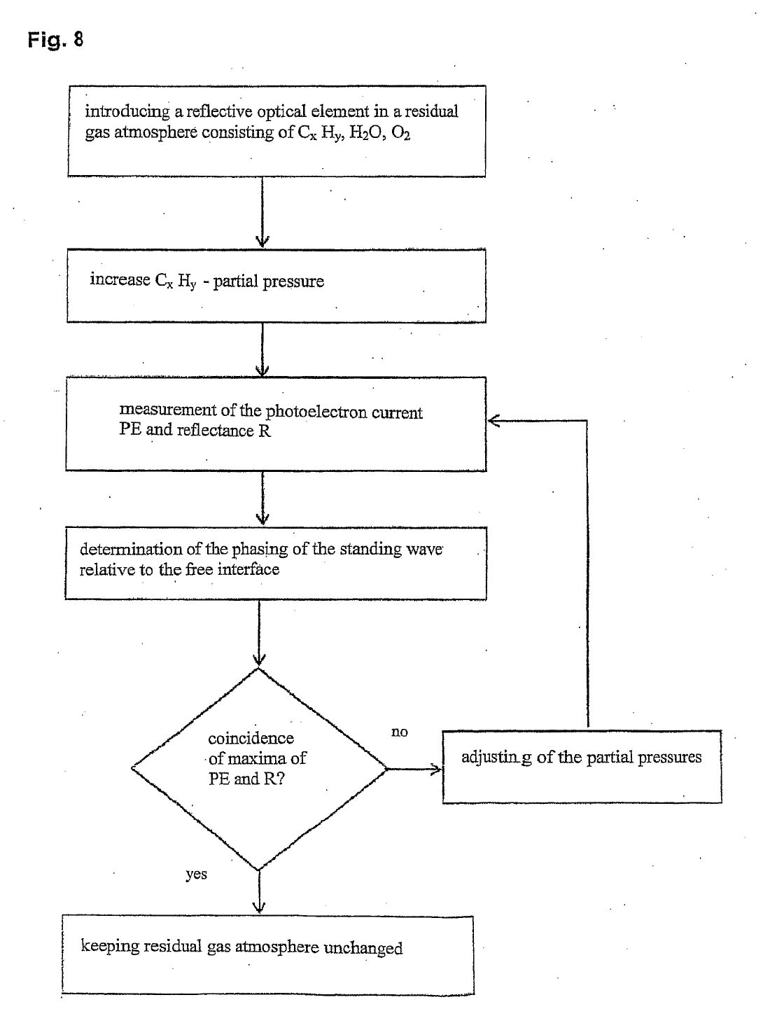

A reflective optical element produced e.g. according to FIG. 1b, the layer thickness of which can be measured e.g. in an apparatus according to FIG. 6, has a design principle shown in FIG. 7. On a substrate 20, periodically repeated layer units j, j+1, n are deposed, in this example, each with four layers 21, 22, 23, 24. These consist in e.g. alternating molybdenum layers 22 and silicon layers 21 with intermediate layers 23, 24 as diffusion barriers. Since the interfaces of the molybdenum and silicon layers 21, 22 are well-defined because of the diffusion barriers 23 and 24 over quite some period of time, the maximum reflectance value may longer be maintained.

On the topmost layer unit n, the cap layer system 30 is attached, which has a constant thickness distribution over the surface in the present example. The cap layer system in this case consists of three layers 31, 32, 33, each with e.g. silicon/molybdenum/silicon, molybdenum/silicon/silicon oxide, or silicon/diffusion barrier/transition metal (both with a topmost cap layer of carbon where appropriate).

In particular, reflective optical elements with transition metals such as gold, platinum, rhodium, ruthenium, palladium, silver, rhenium, osmium and/or iridium, as in the cap layer system of the above example, are typically operated in a residual gas atmosphere with oxidizing and reducing gases, respectively, mixtures of gases for avoiding contamination and increasing lifetime. Thereby, preferably a residual gas atmosphere of a hydrocarbon, water, and oxygen is used. As hydrocarbons, especially hydrocarbons with at least one oxygen atom have been, proved of value, as e.g. ketones and acids. In particular, the use of methyl methacrylates (MMA) has been proved valuable.

This is not only valid for cap layer systems comprising a chemically pure form of a transition metal, but also for cap layer systems with an alloy, compound, or mixture comprising a transition metal.

However, it has turned out that such a residual gas atmosphere also has a positive influence for the operation of reflective optical elements with a topmost cap layer consisting of an oxide or carbon, e.g., a cap layer system of silicon/silicon oxide/carbon, in particular if the reflective optical element is optimized in such a way that an intensity minimum of the standing wave is present at the free interface in the resonant case.

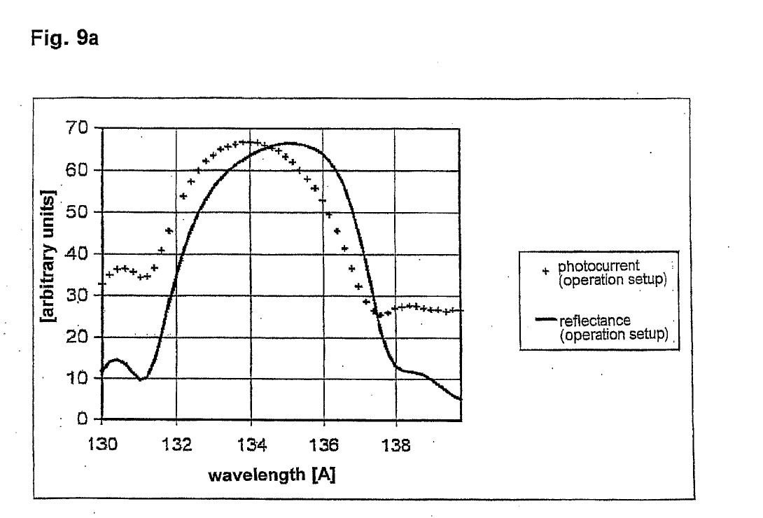

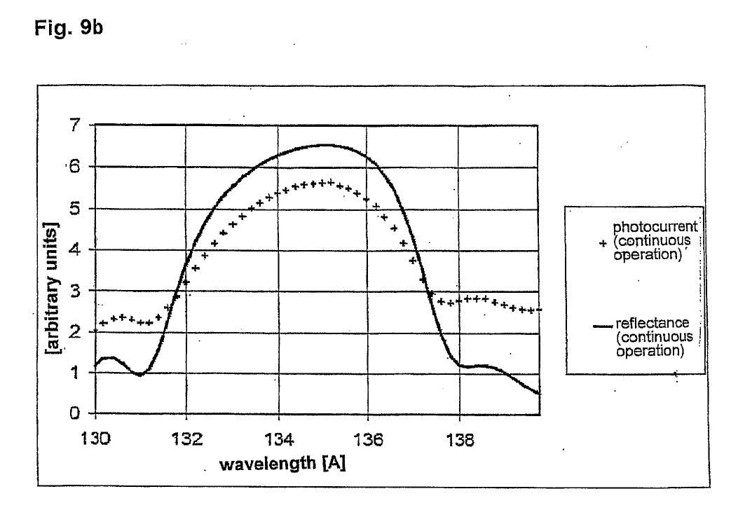

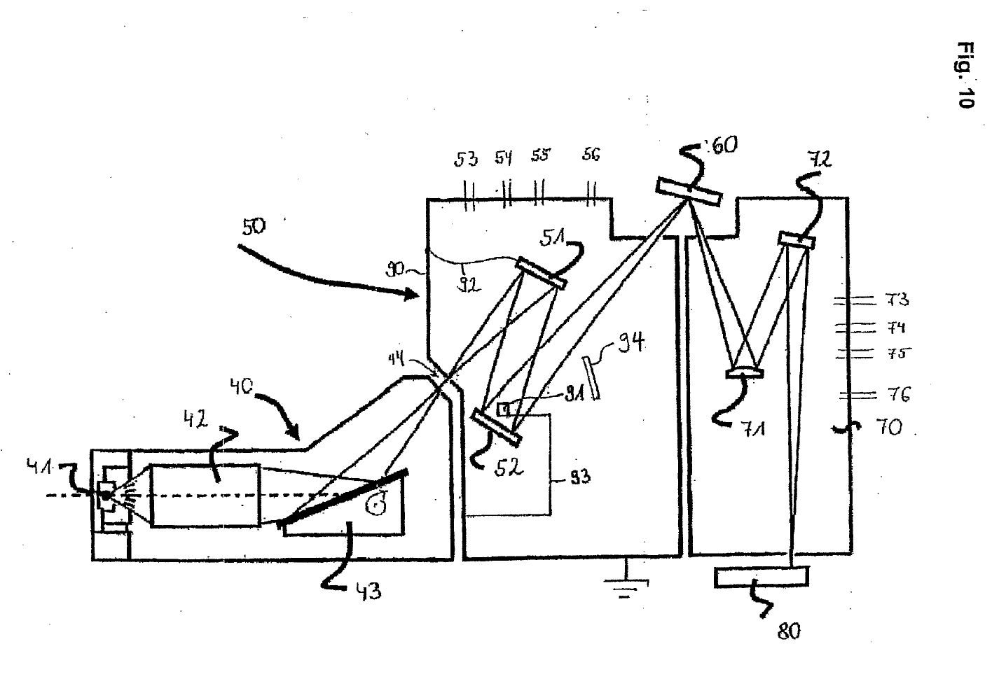

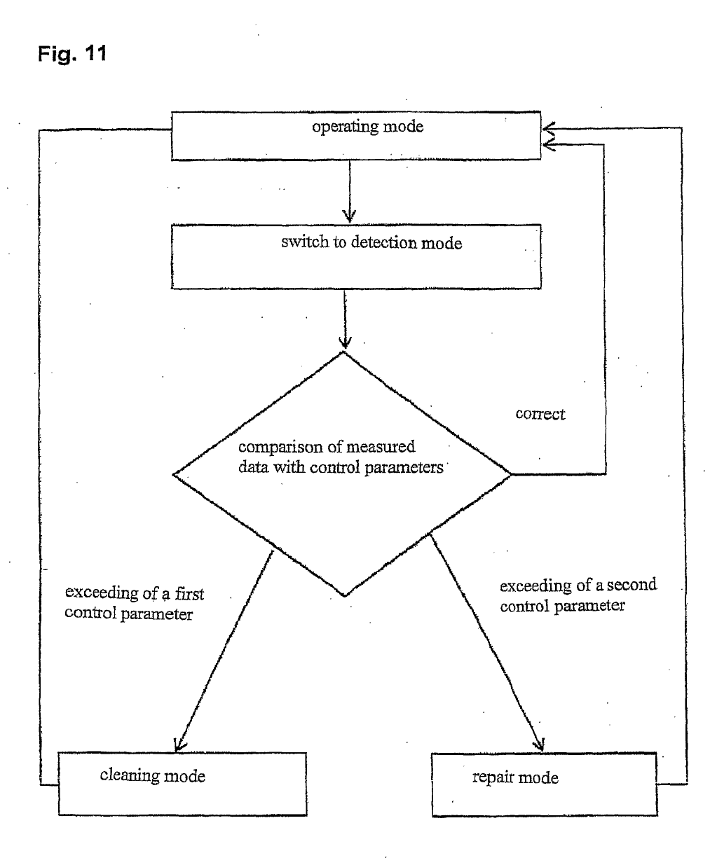

A particularly effective suppression of contaminations is achieved if one designs the cap layer system with a transition metal in such a way that the maximum intensity of the standing electromagnetic wave formed in the resonant case is located in the region of the free interface, in particular somewhat withdrawn from the free interface (see also FIG. 9a). During the set-up of such a reflective optical element, the residual gas atmosphere should first be adjusted by increasing the partial pressure of hydrocarbon in such a way that a carbon layer is grown. By measurements of the reflectance and of the photoelectron current in the manner described above, it can be detected if the maximum reflectance and the maximum photoelectron current are situated on top of each other which means that the maximum of the photoelectron current curve ad the reflectance curve coincide. If not, the individual partial pressures should be readjusted until an equilibrium state is reached in which the maximum reflectance and the maximum photoelectron current are located on top of each other (see also FIG. 9b). This method is illustrated in FIG. 11. Alternatively, it is also possible to choose an equilibrium point in which both maxima are slightly shifted with respect to each other.

If one starts with a reflective optical element in which both maxima are located on top of each other when a thin carbon layer is present, one works in an overall “carbon regime”: during the formation of the carbon layer immediately at the beginning of the irradiation, the gaps in the transition metal layer are also filled with carbon which prevents an oxidation in addition to the carbon layer. If necessary, the carbon layer which is formed when the reflective optical element comes into contact with the normal atmosphere may be sufficient. Excessive carbon atoms are oxidized to carbon dioxide and the carbon gaps are refilled at the same time. For a continuous course of these processes, photoelectrons are accounted for, of which a maximum number is provided at the free interface because the maximum of the intensity of the standing electromagnetic wave is located at the free interface.

For implementing these circumstances also in an EUV-lithography apparatus, the EUV-lithography apparatus roughly shown in FIG. 10 is suited for. It comprises essentially three main components: a part 40 for supplying of a beam, an illumination system 50 for illuminating the reticle 60, and a projection system 70 which serves for imaging the structures on the reticle 60 on the wafer 80. In the present example, the illumination system 50 and the projection system 70 each comprise two mirrors 51, 52, respectively, 71, 72. In this concrete example, all of the mirrors are reflective optical elements of the type described above, i.e. with a cap layer system whose layers have a constant thickness across the mirror surface.

For operating the mirrors 51, 52 and 71, 72 with as few contamination as possible, the illumination system 50 as well as the projection system 70 have valves for adjusting the residual gas atmosphere, in this case e.g. valves 53, 73 for supplying hydrocarbon, valves 54, 74 for supplying water, valves 55, 75 for supplying oxygen, as well as valves 56, 76, used as exhaust valves.

It should be pointed out that it may also be advantageous to place the free interface neither at the intensity maximum nor at the intensity minimum of the standing electromagnetic wave, but at an intermediate position with a sufficiently steep slope of the intensity curve so that the sensitivity of the measurement of the photocurrent can be increased.

For measuring of the photocurrent, two requirements have to be fulfilled: First, spectral narrowing of the radiation originating from a EUV-light source 41 with a continuous spectrum has to be performed, i.e. the bandwidth of the radiation has to be constrained to a narrow range about a center wavelength, and second, the center wavelength has to be tuned over a sufficiently large wavelength band (“spectral forming”). A tunable monochromator in the sense of the present application is a device which allows one to fulfil both of these requirements, whether or not these are realized inside the same physical entity or two or more separate physical entities.

The part 40 of the EUV-lithography apparatus comprises apart from the EUV-light source 41 and a collector 42a grating 43 as a tunable monochromator. The first requirement is fulfilled since the grating 43 serves as a spectral purity filter and the second requirement is met as the grating 43 is rotary mounted such that the angle of incidence may be varied, which allows one to tune the center wavelength in the way described above.

However, other possibilities for forming a tunable monochromator are also possible without making use of the grating 43, one of which is described in the following: The spectral narrowing can e.g. be performed if the illumination system 50 of the EUV-lithography apparatus generates a radiation with a sufficiently narrow bandwidth through multiple reflectances at its reflective optical elements. In the present case, spectral narrowing can be achieved by the mirrors 51, 52 and further reflective optical elements being present in the illumination system 50 (not shown in FIG. 10). Thus, the radiation incident to the projection system 70 already exhibits a sufficiently narrow bandwidth for the measurement of the photocurrent. A very simple possibility of tuning the wavelength is then to use a set of reflective optical elements (“mask blanks”), each having a maximum of reflectance at a different center wavelength. For performing successive measurements, the reticle mask 60 has to be exchanged with each mask blank of the set.

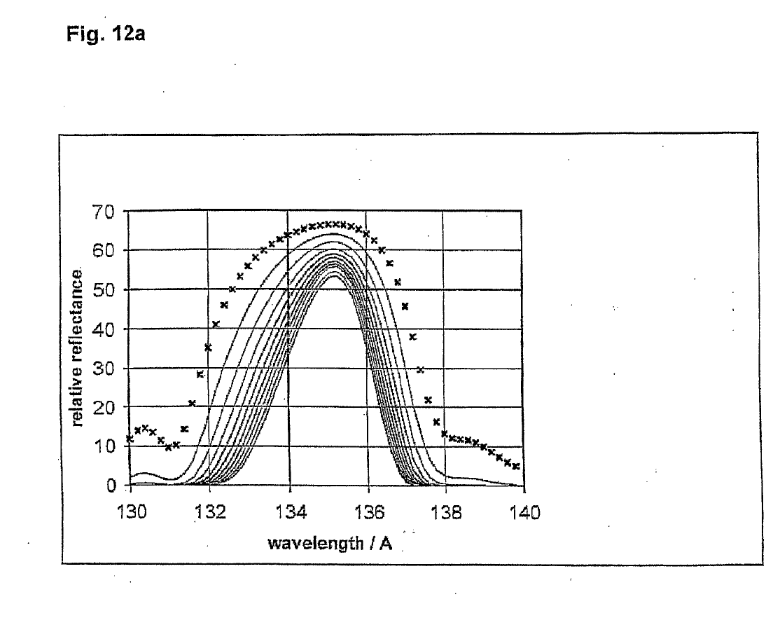

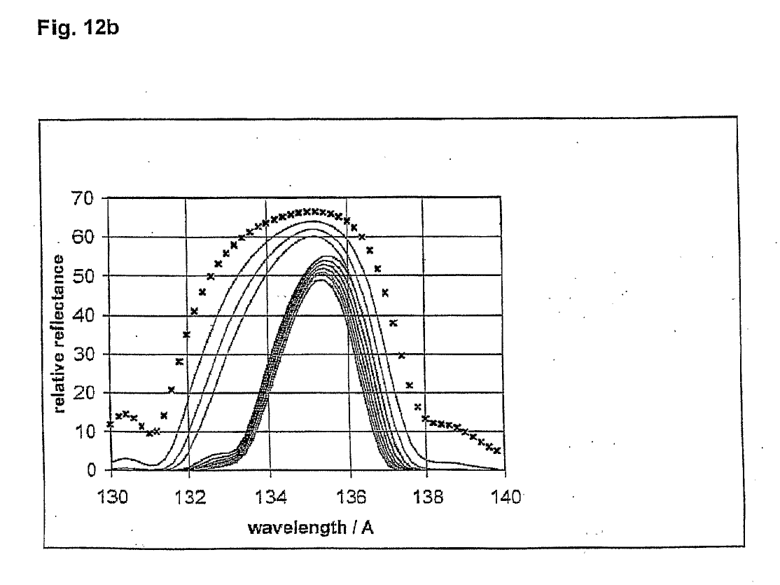

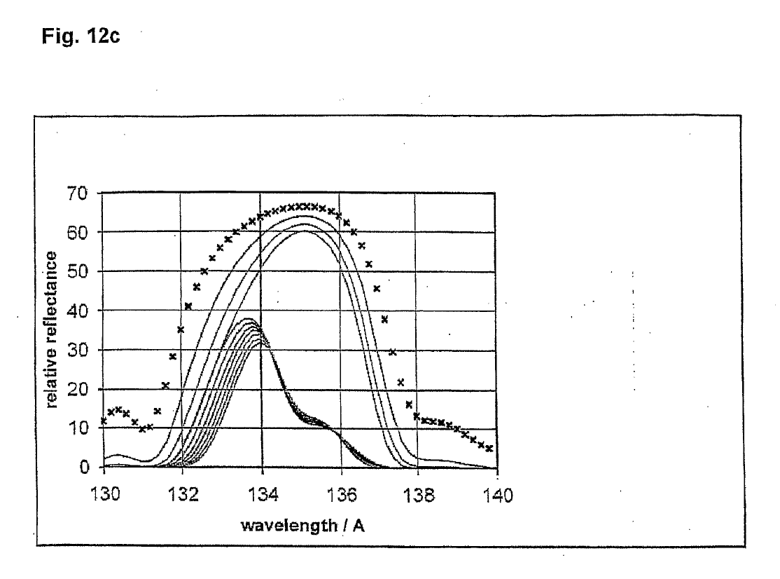

The principle of the wavelength tuning performed in this way is illustrated in FIG. 12a-c, in which the spectral characteristics of the relative reflectance after the reflection from the reflective optical elements of the EUV-lithography apparatus of FIG. 10 are shown, each reflectance curve corresponding to reflectance from one reflective optical element, the reflection at the first reflective optical element (mirror 43) in the illumination system 50 corresponding to the curve with the largest reflectance maximum, the reflection at the last reflective optical element (mirror 72) of the projection system 70 corresponding to the curve with the smallest reflectance maximum. Note, however, that not all of the reflective optical elements of the EUV-lithography apparatus are shown in FIG. 10, so that the number of reflectance curves in FIG. 12 is larger than the number of reflective optical elements shown in FIG. 10.

It is obvious from FIG. 12 that each reflection causes a narrowing of the bandwidth and a reduction of reflectance, i.e. a decrease of intensity of the reflected radiation. The exact amount of the decrease of intensity is not of interest for the present purposes, so that the reflectance curves of FIG. 9 have been conveniently scaled and do not reflect the actual conditions concerning the intensity loss.

In FIG. 12a, all reflective optical elements inside the EUV-lithography apparatus have the same center wavelength, i.e. a maximum of reflectance at about 135 Å, corresponding to the operating wavelength of the EUV-lithography apparatus. By using a reflective optical element with a maximum of reflectance shifted to a higher wavelength, e.g. to about 136 Å, as shown in FIG. 12b, the spectral characteristics of the reflective optical elements in the beam path after this particular wavelength-shifted reflective optical element also exhibit a maximum of reflectance at the new center wavelength. Similarly, FIG. 12c shows the use of a reflective optical element with a maximum of reflectance being shifted to a wavelength of about 134 Å, i.e. below the operating wavelength.

A series of measurements may be performed with a set of wavelength-shifted optical elements as described in connection with FIG. 12, e.g. for an operating wavelength of 135 Å with a set of optical elements having 130 Å, 131 Å, 132 Å, 133 Å, 134 Å, 135 Å, 136 Å, 137 Å, 138 Å, 139 Å, and 140 Å as a center wavelength. It is also possible to refine the step size to 0.1 Å or 0.01 Å. The minimal requirement for performing the tuning is the use of two optical elements with different center wavelengths. The step size and the number of reflective optical elements used for the measurement of the photocurrent has to be chosen in such a way that maximal benefit can be achieved with minimal cost.

The switching of reflective optical elements is in the present embodiment performed by replacing the reticle mask 60 with each of the set of wavelength-shifted reflective optical elements, such that the curves with a non-shifted center wavelength of FIGS. 12b and 12c correspond to optical elements being present in the illumination system 50, i.e. in the beam path before the reticle 60, and the curves with a shifted center wavelength correspond to reflective optical elements in the projection system 70, i.e. in the beam path behind the reticle 60.

By choosing an appropriate spacing of the center wavelengths of different reflective optical elements of the set as described above, it is in principle possible to reproduce the photocurrent curves shown in FIG. 4c, i.e. to distinguish between the contamination states “unexposed”, “10 Å carbon added”, “20 Å carbon added”, and “30 Å carbon added”. Particularly advantageous about this method of tuning is that the construction of EUV-lithography apparatuses does not have to be modified, as the only necessary requirement for performing the method is the possibility of exchanging the reticle mask 60 with the wavelength-shifted reflective optical elements of the set.

As reflective optical elements with a shifted center wavelength, masks can be used which do not have an absorption pattern (so-called “mask blanks”). The difference between the mask blanks and a cleaning reticle is simply that the cleaning reticle does not only cause a wavelength shift, but also has a particular absorption pattern for directing the radiation to the areas to be cleaned. As mask blanks with shifted center wavelengths, “defective” masks may be used, i.e. masks which have been designed e.g. as mirrors having their center wavelength at the operating wavelength, but are shifted with respect to the latter due to manufacturing imperfections. Generally, for fixing a predefined center wavelength, the thickness of the layers of the multilayer system has to be fixed in an appropriate way. However, it is also possible to shift the center wavelength by application of an adequate cap layer having constant absorption characteristics across the whole surface of the optical element.

Of course, the narrowing of the spectral bandwidth can also be performed by using a EUV source with a sufficiently narrow bandwidth (line source) instead of the EUV source 41 of FIG. 10 with a continuous spectrum. In this case, the spectral characteristics of FIG. 12 have to be interpreted as an envelope of the line structure of the line source.

With reference now to the rotatable grating 43, apart from its use for the measurement of the photocurrent, it allows to switch between an operating wavelength for exposure of the wafer 40 and an usable wavelength for detection of contaminations, cleaning and/or repairing of individual optical elements of the EUV-lithography apparatus. Furthermore, the rotation of the grating 43 also allows to perform angular scans for measuring photocurrent and reflectance in dependence of the angle of incidence, respectively, the wavelength at the reflective optical element 51. For this reason, the reflective optical element 51 and an ampere meter (not shown) are connected via a cable 92 with the grounded vacuum chamber 90 of the illumination system 50. In this case, the vacuum chamber 90 is used as an electron collector. Furthermore, a first photon detector 91 is provided, which may be pivoted into the beam path behind the reflective optical element for measuring purposes. The first photon detector 91 is also connected to the grounded vacuum chamber 90 via a cable 93 and an ampere- and/or voltage meter (not shown). Also not shown are the wires which direct the measured signals to a computer for receiving and analyzing data. Of course, other reflective optical elements, respectively, several reflective optical elements may be inspected in-situ with respect to photoelectron current and reflectance, if corresponding detectors are provided.

Preferably, ampere meters are used which allow an adjustment of a defined base voltage. It is also possible to use voltage meters which permit readout of current flows.

The EUV-lithography apparatus shown in FIG. 10 may either be operated in the operation mode, in which the mask 60 is illuminated and its structure is imaged onto the wafer 80. However, it is also possible to switch to the detection mode, in which one or more reflective optical elements are tested with regard to contamination. In the present example, the reflective optical element 51 should be tested, as it is exposed to the highest beam load. Therefore, if necessary, the total pressure inside of the illumination system 50 is first minimized. The surface of the reflective optical element 51 is irradiated and the photoelectron current and the reflectance are measured in dependence of the wavelength. Through the cooperation of monochromator 43, collimator 42, and aperture 44 it may be achieved that different locations at the surface of the reflective optical elements 51 are measured independently of each other. From the determination of the spectral characteristics of photoelectron current and reflectance and/or a comparison of the measured photoelectron current data with modelled data for different contamination states, the contamination state of the reflective optical element 51 is determined.

In particular, for a measurement of reflective optical elements 71, 72 of the projection system 74 for illumination purposes, one resorts to a cleaning reticle, if necessary in combination with an appropriate aperture.

Depending on whether or not certain control parameters of the contamination state are exceeded, either the operation mode, the cleaning mode, or the repair mode are selected. For this purpose, one uses two control parameters, respectively, two sets of control parameters. The exceeding of the first control parameter means that the reflective optical element is so strongly contaminated that cleaning has to be carried through. Exceeding of the second control parameter means that cleaning is not sufficient, such that the reflective optical element has also to be repaired on its surface.

In case that the cleaning mode is selected, the partial pressures of the reductive and oxidizing gas fractions, e.g. of hydrocarbon, water, and oxygen, are modified in dependence of the determined contamination, so that during irradiation with the usable radiation, the contamination on the reflective optical element is reduced. In addition, the incident light beam can be used for photocleaning of the respective optical element. The light for photocleaning may as well be provided by a second light source of the operation wavelength or of another DUV or EUV wavelength. If the contamination is removed sufficiently, the operation mode is again selected.

In case that one has to switch to the repair mode, not only the residual gas atmosphere is adjusted, but also the incoming beam is modified in its cross-section and its position in such a way that material can be deposited and/or removed in a spatially defined way. Therefore, once again, one uses the rotatable grating 40 as well as the collimator 42 and the slit stop 44, respectively, the cleaning reticle for cleaning or repair inside of the projection system 70. As soon as the repair has been carried through, one may switch to the operation mode again. Such a method cycle is shown in FIG. 11 as well.

During execution of the detecting, cleaning and/or repairing inside of the projection system, one may in particular rely on a cleaning reticle (not shown) in addition to the rotatable grating 43 and the collimator 42, through which the ordinary reticle 16 is replaced in the detecting, cleaning and/or repair mode. The structures of the cleaning reticle are optimized in such a way that the optical elements are illuminated selectively, if necessary with spectrally modified radiation, for detecting, cleaning and repair purposes. For this purpose, the cleaning reticle may also be mounted in a rotatable and translatable way.

The switching between the detecting/cleaning and repair mode as well as the operating mode may in particular be accompanied by the following measures: modification of the residual gas composition, modification of possibly applied electrical fields in the region of the trajectories of emitted photoelectrons (e.g. by a ring, grating or cylinder or by setting the reflective optical element to a potential) for directing of the electrons and screening of positive ions and/or modification of the beam characteristics. The modification of the beam characteristics takes place, among other things, through adjusting of the center wavelength, bandwidth, divergence and the intensity at the monochromator and/or the cleaning reticle, through adjusting of the beam diameter, beam angle and the divergence at the collimator, through adjusting the size of the beam spot and the wavelength through masking, respectively, selecting a reflection order with an aperture.

Apart from the wall 90 of the vacuum chamber, one may also use a grating, a wire ring or a cylinder as an electron collector device, which are connected electrically to the reflective optical element to be measured or to mass via an ampere meter. In particular, the reflective optical element to be measured can be connected with an ampere meter through a cable. For this purpose, a measuring device with an adjustable voltage may also be used.

For generating a defined electromagnetic field between the reflective optical element to be measured and the electron collector device, a defined electrical potential is applied by means of an additional component such as e.g. a ring, a cylinder, or a grating. This component may be of an arbitrarily complex shape and is connected to a voltage generator. For generation of a defined electromagnetic field, a defined potential may also be applied to the reflective optical element to be measured.

In addition to the first photon detector 91 arranged in the beam path, a second photon detector 94 is arranged in the projection system 70 which is located outside of the beam path. The second photon detector 94 allows one to detect radiation having a higher wavelength than the operating wavelength, e.g. a wavelength in the infrared wavelength range above 750 nm (corresponding to an energy of approx. 1.65 eV). The second photon detector 94 can be used as a thermal imaging camera generating a spatially resolved two-dimensional image of the optical element 51. Such an image is advantageous already in the operating mode, as the heat transported to each reflective optical element is known beforehand and the image of the temperature distribution contains valuable information about the surface of the inspected optical element. Moreover, a varying two-dimensional energy outflow will result from the variation of narrow-band EUV irradiation in the detection mode because of a change in the photoelectron characteristics which will show up in the thermal image. Moreover, the thermal image is also of use in the cleaning mode and the repair mode.

The detection of photons generated by inelastic scattering from the reflective optical elements of an EUV-lithography apparatus is not only advantageous for photon wavelengths in the infrared range, but may also be applied to photons with any wavelength between the operating wavelength (e.g. 13.5 nm, corresponding to approx 92.5 eV) and wavelengths in the infrared range. The principle underlying this detection method is to detect photons at a low energy scale in which its detection is relatively easy, instead of detecting photons with high photon energies, being difficult to detect. The method makes use of the loss of photon energy due to inelastic scattering and the fact that valuable information about the surfaces of optical elements may be extracted also from inelastically scattered photons.

Photons, unlike electrons, are not influenced by electrical and magnetic fields and may be detected in a robust way by semiconductor detectors. The standing electromagnetic wave being formed at the free interface in the resonant case can be used to selectively excite the photons to be detected. The method may be extended by using a specific design of the cap layer system, e.g. by doping of the cap layer, such that photons with selected photon energies are excited which lie in the desired detection wavelength range.

Of course, the use of the first photon detector 91 for the measurement of the usual reflectance curves is still possible. However, photons scattered in an inelastic way are emitted in all directions, such that they may be detected by the second photon detector 94 at a geometrically advantageous position in the EUV-lithography apparatus, in particular outside of the beam path.

Whereas the invention has been described in connection with preferred embodiments, it is not limited to those.

1. A method for qualifying a reflective optical element having a free interface at which radiation is reflected, the method comprising:
measuring at various wavelengths and/or various incidence angles of the radiation a reflectance and a photoelectron current induced by the radiation in an area of the free interface resulting in: (a) a reflectance curve as a function of wavelength and/or incidence angle wherein the reflectance curve has a wavelength region of maximum reflectance and/or an incidence angle region of maximum reflectance; and (b) a photoelectron current curve as a function of wavelength and/or incidence angle wherein the photoelectron current curve has a profile within the wavelength region of maximum reflectance and/or the incidence angle region of maximum reflectance; and
using the profile of the photoelectron curve for determining a phase shift of a standing electromagnetic wave of incident radiation with respect to the free interface, or using the profile of the photoelectron curve for determining an intensity a standing electromagnetic wave of incident radiation with respect to the free interface.

2-70. (canceled)

71. The method of claim 1, wherein the method includes using the profile of the photoelectron curve to determine a phase shift of a standing electromagnetic wave of incident radiation with respect to the free interface.

72. The method of claim 1, wherein the method includes using the profile of the photoelectron curve to determine an intensity of a standing electromagnetic wave of incident radiation with respect to the free interface.

73. The method of claim 1, further comprising determining the slope of the profile of the photoelectron current curve at the wavelength of maximum reflectance and/or the incidence angle of maximum reflectance.

74. The method of claim 1, further comprising determining a maximum or minimum of the profile of the photoelectron current curve within the wavelength region of maximum reflectance and/or the incidence angle region of maximum reflectance, wherein the wavelength corresponding to the maximum or minimum of the profile of the photoelectron current curve is closest to the wavelength corresponding to the maximum of the reflectance curve.

75. The method of claim 1, wherein the radiation is EUV radiation.

76. The method of claim 1, wherein the wavelength region of maximum reflectance or the incidence angle region of maximum reflectance is from −3% to 1% of the wavelength of maximum reflectance or the incidence angle of maximum reflectance.

77. The method of claim 1, wherein the photoelectron current curve and the reflectance curve are measured at several points on the interface in order to achieve spatial resolution.

78. A method for qualifying a reflective optical element that includes a multilayer system having a free interface at which radiation is reflected and/or a cap layer system and having a free interface at which radiation is reflected, the method comprising:
(i) measuring at various wavelengths and/or incidence angles of the radiation a reflectance and a photoelectron current induced by the radiation in an area of the free interface resulting in: (a) a first reflectance curve as a function of wavelength and/or incidence angle wherein the first reflectance curve has a wavelength region of maximum reflectance and/or an incidence angle region of maximum reflectance; and (b) a first photoelectron current curve as a function of wavelength and/or incidence angle wherein the first photoelectron current curve has a profile within the wavelength region of maximum reflectance and/or the incidence angle region of maximum reflectance;
(ii) comparing the first reflectance curve and/or the first profile with a second reflectance curve and/or a second photoelectron current curve, wherein the second reflectance curve and/or the second photoelectron current curve is obtained by a simulation for a given thickness of the layers of the multilayer system and/or a given thickness of the layers of the cap layer system; and
(iii) if the first reflectance curve and/or the first profile do not approximately coincide with the second reflectance curve and/or the second profile, repeating (ii) with a different thickness of the layers of the multilayer system and/or a different thickness of the layers of the cap layer system,
wherein the method determines a thickness profile of the multilayer system and/or the cap layer system of the optical element.

79. The method of claim 78, wherein the radiation is EUV radiation.

80. The method of claim 78, wherein in (ii) the first profile and/or the first reflectance curve are compared with reference data measured at a reflective optical element with a multilayer system and a cap layer system of known thickness instead of comparing with a second reflectance curve and/or a second photoelectron curve obtained by simulation.

81. The method of claim 80, wherein the photoelectron current curve and the reflectance curve are measured at several points on the interface in order to achieve spatial resolution.

82. An apparatus, comprising:
at least one photoelectron detector and at least one tuneable monochromator, wherein the apparatus is a EUV lithography apparatus.

83. The apparatus of claim 82, wherein a wavelength used in the apparatus can be switched between a first wavelength and a second wavelength, the first wavelength being the wavelength at which the apparatus is operated during exposure, and the second wavelength being the wavelength at which the apparatus is used to qualify optical elements arranged in the apparatus.

84. The apparatus of claim 83, wherein the tuneable monochromator comprises:
a first reflective optical element, comprising:
a first multilayer system with a maximum of reflectance at the first wavelength; and
a second reflective optical element comprising a second multilayer system with a maximum of reflectance at the second wavelength,
wherein the first and second reflective optical elements are preferably interchangeable with an operating reticle used for operating the apparatus during exposure.

85. The apparatus of claim 84, wherein the first wavelength and/or the second wavelength is determined by the given thickness of the layers of the first multilayer system and/or the second multilayer system, respectively.

86. The apparatus of claim 82, further comprising means for adjusting a residual gas atmosphere inside the apparatus.

87. The apparatus of claim 82, further comprising a cleaning reticle.

88. The apparatus of claim 82, further comprising a collimator and/or at least one aperture for geometric beam shaping.

89. The apparatus of claim 82, further comprising means for generating local differences of partial pressures.

90. The apparatus of claim 82, further comprising a first photon detector for detection of photons at the operating wavelength and/or a second photon detector for detection of photons with lower photon energies corresponding to photon energies below about 90 eV.

91. The apparatus of claim 90, wherein the apparatus comprises the second photon detector, and the second photon detector is a thermal imaging camera.
